(19) United States
(12) Patent Application Publication
(10) Pub. No.: US 2020/0096014 A1
(43) Pub. Date: Mar. 26, 2020

(54) CYLINDER DEVICE, PRESSMACHINE, WORKPIECE CLAMPING APPARATUS, CYLINDER DEVICE ACTUATING METHOD, METHOD FOR PRESSING WORKPIECE, AND METHOD FOR CLAMPING WORKPIECE

(71) Applicant: Seiko Instruments Inc., Chiba-shi (JP)

(72) Inventor: Shigehiro ARAI, Chiba-shi (JP)

(21) Appl. No.: 16/582,869

(22) Filed: Sep. 25, 2019

(30) Foreign Application Priority Data
Sep. 26, 2018 (JP) 2018-180230
Aug. 23, 2019 (JP) 2019-152505

(51) Int. Cl. F15B 11/072; B30B 15/00; B25B 1/18; F15B 9/16

(52) U.S. Cl. CPC F15B 11/0725; F15B 9/16; B25B 1/18; B30B 15/0052

(57) ABSTRACT

By setting an outer circumferential surface of a second hydraulic chamber of a cylinder device to be a thin portion, hydraulic pressure increases by receiving air pressure from the second pneumatic chamber, and the thin portion expands to clamp a cylinder. Then, by the increase of the second hydraulic chamber, expansion of the thin portion in an axial direction is suppressed and the thin portion expands in a radial direction, and thus, as means for suppressing expansion in the axial direction, the thin portion is fixed from both end sides thereof with an expansion stop bolt. The expansion stop bolt fixes a lid and a lid disposed so as to sandwich pressed portions on both end sides of the thin portion or both ends of the thin portion. Further, in order to prevent the thin portion from being shrunk by tightening with the expansion stop bolt, a spacer is disposed between the pressed portions on both end sides of the thin portion.

### RELATED APPLICATIONS

This application claims priority to Japanese Patent Application No. 2018-180230, filed on Sep. 26, 2018 and Japanese Patent Application No. 2019-152505, filed on Aug. 23, 2019, the content of which is incorporated herein by reference.

### BACKGROUND OF THE INVENTION

### 1. Field of the Invention

The present invention relates to a cylinder device, a pressmachine, a workpiece clamping apparatus, a cylinder device actuating method, a method for pressing workpiece, and a method for clamping workpiece, such as a technology in which a fluid pressure cylinder is used.

### 2. Description of the Related Art

A fluid pressure cylinder using a fluid such as air (a gas) or oil (a liquid) is used in many industrial fields.

The fluid pressure cylinder generates thrust on a piston in a cylinder due to pressure of a fluid such that the thrust can be a drive force of various types of mechanical actuation such as driving of a press or an actuator.

However, a hydraulic cylinder has a characteristic in that even a small hydraulic cylinder generates large thrust due to a high pressure force by hydraulic pressure; however, a problem arises in that large-scale equipment such as a hydraulic pressure supply device is required.

Therefore, Japanese Patent No. 4895342 proposes a fluid pressure cylinder that generates hydraulic pressure with air pressure by an air hydraulic cylinder (air hydraulic mechanism) obtained by combining an air cylinder and a hydraulic cylinder such that a complex hydraulic system is omitted and the fluid pressure cylinder can be decreased in costs and size.

However, in a technology in Japanese Patent No. 4895342, the thrust is generated by associating a movement distance of a piston of the air cylinder with a sectional area of the hydraulic cylinder, and thus a problem of a short stroke arises.

For example, in a case where an actuator is disposed on an output side of the air hydraulic cylinder, it is necessary to cause the actuator to move together with the air hydraulic cylinder in order to secure a stroke.

Therefore, the applicant of the present patent has filed an application (Japanese Patent Application No. 2018-21723 (unpublished)) for a cylinder device that largely moves the entire air hydraulic mechanism by air, fixes the air hydraulic mechanism to the cylinder using expansion due to the increase of hydraulic pressure, and in the fixed state, outputs a large thrust by the air hydraulic mechanism.

In the cylinder device, a second hydraulic chamber having the thin portion formed on the circumferential surface is connected to the air hydraulic mechanism, the thin portion expands by the increase in hydraulic pressure of the second hydraulic chamber, and accordingly, the air hydraulic mechanism is fixed to the cylinder.

However, since there is a case where the thin portion of the second hydraulic chamber not only expands in a radial direction but also expands in a thrust direction, not all of the pressure increase in the second hydraulic chamber can be used for the expansion in the radial direction.

### SUMMARY OF THE INVENTION

An object of the invention is to effectively use an increased fluid pressure for fixing an air hydraulic mechanism to a cylinder device having a long stroke using an air hydraulic mechanism.

(1) According to a first aspect of the invention, there is provided a cylinder device including a cylinder; an output-side housing disposed in the cylinder and movable in the cylinder in a thrust direction; an input-side housing fixed to an input side of the output-side housing and including a second fluid chamber in which a part of an inner surface is formed of a lid on one side and a lid on the other side in the thrust direction, and a fixing mechanism portion of which an outer circumferential surface expands in a radial direction due to an increase in pressure of the second fluid chamber and is fixed to the cylinder; an air hydraulic mechanism disposed in the output-side housing and outputting a thrust by an amplified fluid pressure in a state of being fixed by the fixing mechanism portion; a second pneumatic chamber to which air is supplied; a second piston portion which receives air pressure of the second pneumatic chamber to move the input-side housing and the output-side housing to an output side, and pressurizes and expands the second fluid chamber at a predetermined position; and distance fixing means for fixing a distance between the lid on the one side and the lid on the other side.

(2) According to a second aspect the invention, in the cylinder device of the first aspect, the air hydraulic mechanism includes a first pneumatic chamber to which air is supplied, a first piston having an air pressure receiving surface that forms one surface of the first pneumatic chamber, a first rod disposed on the first piston and having a rod end surface smaller in area than the air pressure receiving surface, a first fluid chamber in which one surface is formed by the end surface of the first rod, an output piston that forms another one surface of the first fluid chamber and has a fluid pressure receiving surface larger than the end surface of the first rod, and an output rod disposed on the output piston and outputting a thrust to the outside by a pressure of the first fluid chamber.

(3) According to a third aspect of the invention, in the cylinder device of the first or second aspect, at least one of the first fluid chamber and the second fluid chamber is formed by a hydraulic chamber.

(4) According to a fourth aspect of the invention, in the cylinder device of the second or third aspect, the distance fixing means penetrates the second fluid chamber, and fixes the lid on the one side and the lid on the other side provided on the output-side housing with a bolt.

(5) According to a fifth aspect of the invention, in the cylinder device of any one of the second to fourth aspects, the distance fixing means has a spacer disposed in the second fluid chamber and disposed between the lid on the one side and the lid on the other side while abutting on the lids.

(6) According to a sixth aspect of the invention, in the cylinder device of any one of the first to fifth aspects, the second piston portion includes a second piston disposed between the input-side housing and the second pneumatic chamber and receiving pressure from the second pneumatic chamber to move to the output side, and a second rod disposed on the second piston and pressurizing the second fluid chamber by moving to the output side of the second piston.

(7) According to a seventh aspect of the invention, in the cylinder device of the sixth aspect, a third pneumatic chamber provided on the other end side in the cylinder and moving the input-side housing and the output-side housing to the input side, is further provided.

(8) According to an eighth aspect of the invention, there is provided a pressmachine including the cylinder device of the seventh aspect; workpiece mounting means for mounting a workpiece at a predetermined position with respect to the cylinder device; press means for pressing the mounted workpiece by a tool disposed on the output rod by driving the cylinder device; and detachment means for detaching the pressed workpiece from the predetermined position.

(9) According to a ninth aspect of the invention, there is provided a workpiece clamping apparatus including the cylinder device of the seventh aspect; workpiece mounting means for mounting a workpiece at a predetermined position with respect to the cylinder device; means for pressing and clamping the mounted workpiece by the output rod by driving the cylinder device; and means for detaching the fixed workpiece from the predetermined position.

(10) According to a tenth aspect of the invention, there is provided a cylinder device actuating method for actuating the cylinder device of the seventh aspect, the method including a first step of setting an initial state by moving the input-side housing and the output-side housing to the input side by pressurizing the third pneumatic chamber and depressurizing the first pneumatic chamber and the second pneumatic chamber; a second step of causing the output rod to abut on a pressing target or causing the output-side housing to abut on an end portion on the output side of the cylinder by moving the input-side housing and the output-side housing to the output side by pressurizing the first pneumatic chamber and depressurizing the third pneumatic chamber; a third step of fixing the input-side housing and the output-side housing to the cylinder by further pressurizing the second pneumatic chamber to move the second piston and the second rod to the output side and pressurize the second fluid chamber; a fourth step of pressing the output rod to the target with the amplified fluid pressure of the first fluid chamber by pressurizing the second pneumatic chamber and actuating the air hydraulic mechanism; and a fifth step of returning to the initial state by moving the input-side housing and the output-side housing to the input side by pressurizing the third pneumatic chamber and depressurizing the first pneumatic chamber and the second pneumatic chamber.

(11) According to an eleventh aspect of the invention, there is provided a method for pressing a workpiece by actuating the press/machine of the eighth aspect, the method including a first step of setting an initial state by moving the input-side housing and the output-side housing to the input side by pressurizing the third pneumatic chamber and depressurizing the first pneumatic chamber and the second pneumatic chamber; a second step of mounting the workpiece at a predetermined position; a third step of moving the input-side housing and the output-side housing to the output side until the output rod abuts on the workpiece and stops by pressurizing the first pneumatic chamber and depressurizing the third pneumatic chamber; a fourth step of fixing the input-side housing and the output-side housing to the cylinder by further pressurizing the second pneumatic chamber to move the second piston and the second rod to the output side and pressurize the second fluid chamber; a fifth step of amplifying fluid pressure of the first fluid chamber by pressurizing the second pneumatic chamber and actuating the air hydraulic mechanism; a sixth step of pressing the workpiece by pressing the workpiece with the fluid pressure amplified in the fifth step by a tool disposed on the output rod; a seventh step of detaching the output rod and the tool disposed on the output rod from the workpiece by pressurizing the third pneumatic chamber and depressurizing the first pneumatic chamber and the second pneumatic chamber; and an eighth step of detaching the pressed workpiece from the predetermined position.

(12) According to a twelfth aspect of the invention, there is provided a method for clamping a workpiece at a predetermined position by actuating the workpiece clamping apparatus of the ninth aspect, the method including a first step of setting an initial state by moving the input-side housing and the output-side housing to an input side by pressurizing the third pneumatic chamber and depressurizing the first pneumatic chamber and the second pneumatic chamber; a second step of mounting the workpiece at a predetermined position; a third step of moving the input-side housing and the output-side housing to an output side until the output rod abuts on the workpiece and stops by pressurizing the first pneumatic chamber and depressurizing the third pneumatic chamber; a fourth step of fixing the input-side housing and the output-side housing to the cylinder by further pressurizing the second pneumatic chamber to move the second piston and the second rod to the output side and pressurize the second fluid chamber; a fifth step of amplifying fluid pressure of the first fluid chamber by pressurizing the second pneumatic chamber and actuating the air hydraulic mechanism; and a sixth step of pressing the workpiece by the output rod with fluid pressure amplified in the fifth step and clamping the workpiece at the predetermined position.

(13) According to a thirteenth aspect of the invention, in the cylinder device of any one of the second to seventh aspects, an output air passage penetrating the second piston portion for supplying air of the second pneumatic chamber to the first pneumatic chamber; and a check valve disposed on the output air passage, and sets the output air passage in an open state in a state where the fixing mechanism portion fixes the input-side housing to the cylinder, are further provided.

(14) According to a fourteenth aspect of the invention, in the cylinder device of the thirteenth aspect, a third pneumatic chamber formed on the output side of the output-side housing to move the output-side housing to the input side by supply of air; a first air passage for supplying the air supplied to the third pneumatic chamber to a fourth pneumatic chamber formed on the output side of the first piston; a second air passage for supplying the air supplied to the third pneumatic chamber to a fifth pneumatic chamber formed on the output side of the second piston; and an open/close valve disposed on the second air passage and opening and closing the second air passage in accordance with the movement of the first piston, are further provided, and the open/close valve opens the second air passage after the first piston moves to the input side and discharge of air in the first pneumatic chamber is completed.

According to the invention, by moving the output-side housing on which the air hydraulic mechanism is disposed in the cylinder by the second pneumatic chamber to which the air is supplied, it is possible to secure both of the stroke and the thrust.

In addition, since the distance fixing means fixes the distance between the lid on one side and the lid on the other side that configure a part of the inner surface of the second hydraulic chamber, it is possible to suppress the expansion of the second hydraulic chamber in the thrust direction, and to effectively expand in the radial direction.

### BRIEF DESCRIPTION OF THE DRAWINGS

FIGS. 1A and 1B are views for describing a cylinder device of a first embodiment.

FIGS. 2A, 2B and 2C are component views of the first embodiment.

FIGS. 3A, 3B and 3C are explanatory views of a spacer in the first embodiment.

FIGS. 4A, 4B and 4C are explanatory views illustrating an actuation state of the first embodiment.

FIGS. 5A, 5B and 5C are explanatory views illustrating another actuation state of the first embodiment.

FIGS. 6A and 6B are views for describing a cylinder device of a second embodiment.

FIGS. 7A, 7B and 7C are explanatory views illustrating an actuation state of the second embodiment.

FIGS. 8A, 8B and 8C are explanatory views illustrating another actuation state of the second embodiment.

FIGS. 9AA, 9AB, 9AC and 9AD and 9BA, 9BB, 9BC and 9BD are views for illustrating press working.

FIG. 10 is a component view of an internal switching valve in a third embodiment.

FIGS. 11A and 11B are explanatory views illustrating an actuation state of the third embodiment.

### DETAILED DESCRIPTION OF THE PREFERRED EMBODIMENTS

### (1) Outline of Embodiments

In cylinder devices 1 and 1b according to the embodiments (first embodiment and second embodiment), there is provided a cylinder device(air hydraulic cylinder) having a characteristic of an air cylinder part having small thrust and long stroke, and a characteristic of an air hydraulic mechanism that converts the thrust input at air pressure using a principle of Pascal into fluid pressure amplified on an output side and outputs large thrust, in one cylinder.

In the air hydraulic mechanism, any fluid may be used as the fluid to be used at an output part as amplified fluid pressure as long as the fluid is a gas, liquid, or gel-like substance having fluidity, but hydraulic oil which is likely to be available and is an incompressible fluid, or the like, is optimal. Accordingly, in the following description, a fluid chamber for amplifying a thrust by the air hydraulic mechanism will be described as a hydraulic chamber, and a fluid used therein will be described as oil.

In the cylinder device, a piston housing 60 (61 to 63) movable in a thrust direction is disposed in a cylinder 2, and three functions including a moving function of moving the piston housing 60 largely in the thrust direction, a fixing function of fixing (clamping from the inside) the piston housing 60 to the cylinder 2 after the movement, and a hydraulic pressure output function of generating a high hydraulic pressure amplified by the air hydraulic mechanism, are realized by an air pressure system formed by a pneumatic chamber 20 (first pneumatic chamber 21 and second pneumatic chamber 22) and a hydraulic system formed by a hydraulic chamber 30 (first hydraulic chamber 31 and second hydraulic chamber 32).

In other words, in order from the output side, the first hydraulic chamber 31, the first pneumatic chamber 21, the second hydraulic chamber 32 (above, disposed in the piston housing 60, and the piston housing 60 forms a part of each), and the second pneumatic chamber 22 are disposed, the moving function is realized by air driving of the second pneumatic chamber 22, the fixing function is realized by air drive of the second pneumatic chamber 22 and an increase in hydraulic pressure of the second hydraulic chamber 32, and the hydraulic pressure output function is realized by the first pneumatic chamber 21 and the first hydraulic chamber 31.

The actuation by the moving function and the fixing function of the piston housing 60 and the actuation by the subsequent hydraulic pressure output function can be performed separately.

Here, the air hydraulic mechanism is a mechanism that amplifies an air pressure supplied to the first pneumatic chamber 21 into a high hydraulic pressure and outputs the amplified hydraulic pressure from an output rod 7 by combining an air piston (first piston portion =first piston 11 and first rod 50) that configure one surface of the first pneumatic chamber 21, and a hydraulic pressure piston (third piston portion =third piston 13 and output rod 7) that configure one surface of the first hydraulic chamber 31.

The second hydraulic chamber 32 of the embodiment has a structure in which, by forming an outer circumferential surface of the piston housing 60 that forms a part thereof thin (thin portion 15), the hydraulic pressure increases by receiving the air pressure from the second pneumatic chamber 22 via the second piston portion (second piston 12 and second rod 58) and the thin portion 15 that functions as a fixing mechanism portion expands and clamps the cylinder 2.

Then, by the increase in hydraulic pressure of the second hydraulic chamber 32, expansion of the thin portion 15 in an axial direction (thrust direction) is suppressed and the thin portion 15 expands in a radial direction, and thus, as means for suppressing expansion in the axial direction, the thin portion 15 is fixed from both end sides thereof with an expansion stop bolt 34g. By fixing a lid 39 and a lid 34 disposed so as to sandwich thick portions on both end sides of the thin portion 15 or both ends of the thin portion 15, and accordingly, the expansion stop bolt 34g functions as distance fixing means.

Further, in order to prevent the thin portion 15 from being shrunk by tightening with the expansion stop bolt 34g, a spacer 80 is disposed between the thick portions on both end sides of the thin portion 15 or both ends of the thin portion 15.

### (2) Details of Embodiments

### First Embodiment

Hereinafter, a first embodiment will be described.

In the first embodiment, in the actuation of the moving function, by moving the second piston 12 that forms a part of the second pneumatic chamber in the axial direction, the piston housing 60 (61 to 63) is moved in the axial direction, and in the actuation of the fixing function, by the actuation of the second piston portion, by generating the hydraulic pressure in the radial direction in the second hydraulic chamber 32, the thin portion 15 expands in the radial direction and the movement of the piston housing 60 is fixed to the cylinder 2.

Meanwhile, in the actuation of the hydraulic pressure output function, a front end of the first rod 50 pushes the first hydraulic chamber 31 by the movement of the first piston 11 to generate the amplified hydraulic pressure from the third piston 13 to the output rod 7.

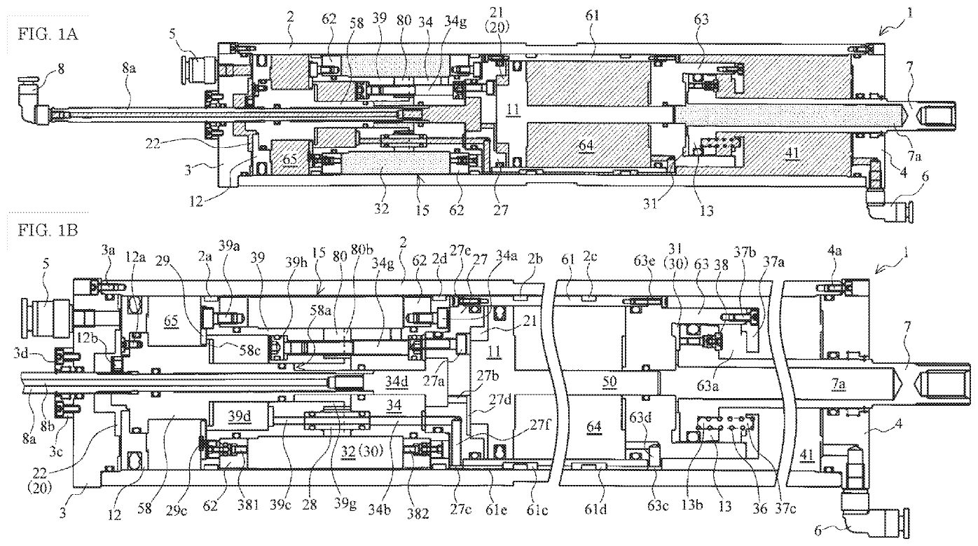

Since FIGS. 1A and 1B are sectional views in the thrust direction (the direction of the centerline) illustrating the configuration of the cylinder device 1 according to the first embodiment, FIG. 1A illustrates the entire sectional view and FIG. 1B illustrates an enlarged part.

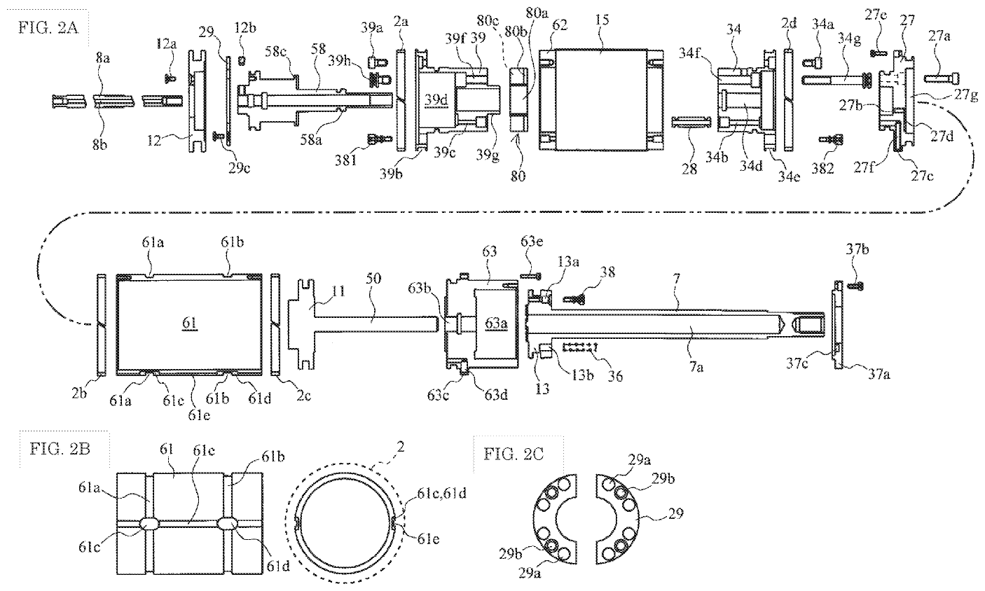

Since FIGS. 2A to 2C illustrate each component disposed in the cylinder 2, FIG. 2A illustrates a section of each component, and FIG. 2B illustrates a front view and a side view of the first housing 61 and a front view of a retaining ring 29.

In addition, the same reference numerals will be given to the parts having the same structure or the same function as those of the first embodiment, and the description thereof will be omitted appropriately. Further, in FIG. 1B, although an O-ring for sealing each part is displayed, the description thereof will be omitted. In addition, in order to make it easy to understand the drawings, similar to the other embodiments, the display indicating the section is not illustrated, and only in FIG. 1A, oblique lines are given to a region where the air exists and dots are given to a region where oil exists.

In addition, in FIGS. 1A to 2C, in order to display each component that forms the cylinder device 1, the position (angle) of the section on the inside of the piston housing 60 (particularly in a second housing 62) is appropriately changed and displayed.

As illustrated in FIGS. 1A to 2C, the cylinder device 1 of the embodiment includes the cylindrical cylinder 2 of which both end surfaces are open, and lids 3 and 4 that close both open end sides thereof. The lids 3 and 4 are fixed to the cylinder 2 by a plurality of bolts 3a and 4a, respectively, disposed in a circumferential direction.

Materials of components (except for specific components, such as an O-ring and a slide assist ring) that configure the cylinder device 1 of the embodiment are metal, such as aluminum, stainless steel, or iron.

As an example of the size of the cylinder device 1, an outer diameter is approximately 60 mm and a stroke length of the output rod 7 is approximately 50 mm, however, the size may be larger or smaller than those described above.

Hereinafter, one end side (lid 3 side) on which a first inlet/outlet 5 is formed is referred to as an input side because the one end side is a side on which the air for movement and pressurization is input, and the other end side (lid 4 side) on which the second inlet/outlet 6 is formed is referred to as an output side because the other end side is a side on which the hydraulic pressure is output.

In addition, a state illustrated in FIG. 1A where the components in the cylinder 2 are positioned on the most input side is referred to as the initial state.

In the cylinder 2, the piston housing 60 (not illustrated) including the first housing 61, the second housing 62, and the third housing 63 is disposed in the cylinder 2.

In the piston housing 60, as illustrated in FIGS. 1A and 1B, the second housing 62, the first housing 61, and the third housing 63 are disposed in order from the input side.

The second housing 62 accommodates the second piston 12 and the second rod 58 connected to the second piston 12, the first housing 61 accommodates the first piston 11 and the first rod 50 connected to the first piston 11, and the third housing 63 accommodates the third piston 13 and a part of the output rod 7 connected to the third piston 13.

Both end sides of the second housing 62 are formed as thick portions, the thin portion 15 is formed therebetween, and the inside of the thin portion 15 is the second hydraulic chamber 32.

In the thick portions at both ends of the second housing 62, oil supply holes for filling the second hydraulic chamber 32 with oil are formed, and after oil is injected from either one, the second hydraulic chamber 32 is sealed by an oil filler plug 381 and an oil filler plug 382.

The lid 39 is fixed to an end portion on the input side in the second housing 62 by a plurality of bolts 39a disposed on a circumference. The lid 39 includes a flange portion fixed to the thick portion (input side) of the second housing 62 by the bolt 39a, and a protruding portion that protrudes to the inner side (central side) of the second housing 62 than the thick portion (input side) of the second housing 62. On the front end side of the protruding portion, a tubular small-diameter projecting portion 39g, into which a part of the spacer 80 (will be described later) in the axial direction is inserted, is formed.

In the protruding portion of the lid 39, a cylindrical recessed portion 39d (refer to FIG. 2A) is formed on the input side, a through-hole for the second rod 58 is formed at the center of a bottom portion of the recessed portion 39d, and two communication holes 39c that penetrate the protruding portion from the bottom portion of the recessed portion 39d are formed on the outside of the through-hole in the radial direction (only one communication hole is illustrated in the drawing). The communication hole 39c forms a part of a path (second air passage) for communicating with a fifth pneumatic chamber 65 and a third pneumatic chamber 41 (will be described later).

The outer diameter of the flange portion formed in the end portion of the lid 39 on the input side is formed to be smaller than the inner diameter of the cylinder 2, and accordingly, a clearance with an inner circumferential wall of the cylinder 2 is provided. A circumferential groove 39b (refer to FIG. 2A) is formed over the entire circumference on the outer circumferential surface of the flange portion of the lid 39, and a slide assist ring 2a is disposed in the circumferential groove 39b.

The slide assist ring 2a is formed of a material other than metal (for example, resin) including the other slide assist rings 2b, 2c, and 2d, avoids metal contact with the cylinder 2 and the lid 39, the fiat housing 61, and the lid 34, and is disposed for making the sliding of the inner circumferential surface of the cylinder 2 and the second housing 62 smooth.

At the protruding portion of the lid 39, four through-holes 39f that penetrate the protruding portion from the bottom portion of the recessed portion 39d are formed (refer to FIG. 2A).

On the inner circumferential surface of the through-hole 39f, female screws for the expansion stop bolt 34g and a locking bolt 39h are formed. The expansion stop bolt 34g is screwed into the through-hole 39f in a direction from the output side to the input side, and the locking bolt 39h is screwed from the opposite side.

The expansion stop bolt 34g is inserted from the lid 34 side and fixed to the lid 34 at a head portion thereof, and the screw portion of the front end is screwed into the through-hole 39f of the lid 39, and accordingly, the distance between the lid 34 and the lid 39 are fixed. Accordingly, the expansion of the thin portion 15 of the second housing 62 in the axial direction is suppressed.

Meanwhile, the locking bolt 39h is screwed into the through-hole 39f from the recessed portion 39d side of the lid 39 until the front end portion of the locking bolt abuts on the front end portion of the expansion stop bolt 34g and biases the expansion stop bolt 34g in an output direction. Accordingly, the expansion stop bolt 34g avoids becoming loose due to an expansion and contraction load generated by repetition of the expansion of the thin portion 15 by the pressurization of the second hydraulic chamber 32 and the contraction by the depressurization.

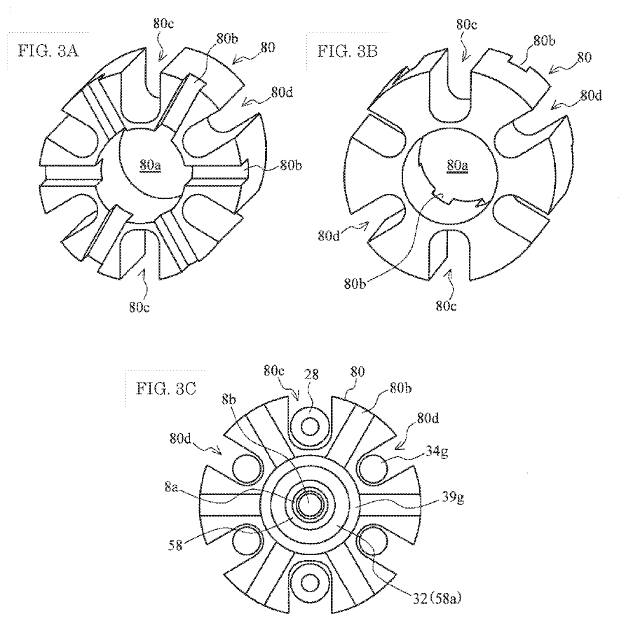

In addition, although the through-holes 39f and the communication holes 39c formed on the lid 39 are illustrated as existing on the same surface in FIG. 2A, the actual positional relationship is not the same plane, and four through-holes 39f and two communication holes 39c are formed at positions avoiding interference with each other. The positional relationship between the expansion stop bolt 34g screwed into the through-hole 39f and a collar 28 inserted into the communication hole 39c is as described later with reference to FIG. 3C.

A second rod 58 is inserted into and penetrates the recessed portion 39d of the lid 39 and the through-hole at the center. On the input side of the second rod 58, a second piston 12 is fixed by a connecting screw 12a.

The second rod 58 has a diameter gradually increasing from the output side to the input side, and includes a small-diameter portion, a medium-diameter portion, a large-diameter portion, and a stepped portion 58a is formed at a boundary between the small-diameter portion and the medium-diameter portion. By moving the second rod 58 in the output direction in the lid 39, the stepped portion 58a pressurizes the second hydraulic chamber 32 formed in the second housing 62, the thin portion 15 is elastically deformed in the radial direction due to the pressurized hydraulic pressure, and the piston housing 60 (61 to 63) is fixed in the cylinder 2.

A flange portion 58c that protrudes in the radial direction is formed on the end surface on the output side of the large-diameter portion of the second rod 58.

In a state where the front end side of the flange portion 58c of the second rod 58 passes into the recessed portion 39d of the lid 39, the retaining ring 29 is fixed to the lid 39 from the input side with a bolt 29c. Since the inner diameter of the retaining ring 29 is formed to be larger than the large-diameter portion of the second rod 58 and smaller than the outer shape of the flange portion 58c, the second rod 58 does not come off.

As illustrated in FIG. 2C, the retaining ring 29 is divided into two, and a plurality of through-holes 29a through which bolts 39a (for fixing the lid 39) penetrate and a plurality of bolt holes 29b for fixing the retaining ring 29 to the lid 39 with the bolts 29c, are formed on the same circumference. Further, the seam divided into two does not adhere even when being attached to the lid 39 and a gap exists, and the air on the inside of the fifth pneumatic chamber 65 and the air on the inside of the communication hole 39c can freely go back and forth.

In a state where the retaining ring 29 is fixed, the second piston 12 is fixed to the second rod 58 with the connecting screw 12a. In this manner, the reason why the second rod 58 and the second piston 12 are divided is to fix the lid 39 with the bolt 39a and fix the retaining ring 29 with the bolt 29c.

A through-hole is formed at the center of the second rod 58, and intake/exhaust rods 8a are inserted into the through-holes. The intake/exhaust rods 8a are screwed together at the end portion of the second rod 58 on the input side. Furthermore, the end portion of the second rod 58 on the input side projects further than the end surface of the second piston 12 to the input side, and in the projection portion, the intake/exhaust rods 8a are fixed in the radial direction with a fixing screw 12b.

In the lid 3 of the embodiment, a through-hole is formed in the center portion, and the intake/exhaust rods 8a are inserted into the through-hole of the lid 3 and the through-hole of a seal lid 3c. The seal lid 3c is fixed to the lid 3 with a plurality of bolts 3d in a state where the seal lid 3c is inserted into the intake/exhaust rods 8a by an O-ring.

An intake/exhaust path 8b for supplying (gas) to the first pneumatic chamber 21 is formed in the intake/exhaust rod 8a.

The end portion of the intake/exhaust rod 8a on the input side is connected to a third inlet/outlet 8.

In the second piston 12, the end surface on the input side forms the second pneumatic chamber 22 together with the lid 3 and the inner circumferential surface of the cylinder 2, and the end surface on the output side forms the fifth pneumatic chamber 65 together with the lid 39 and the cylinder 2.

On the output side of the second housing 62, a part (protruding portion) of the lid 34 is inserted facing the lid 39. The lid 34 includes a flange portion fixed to the thick portion (output side) of the second housing 62 with the bolt 34a, and a protruding portion that protrudes to the inner side (central side) of the second housing 62 than the thick portion (output side) of the second housing 62.

The outer diameter of the flange portion of the lid 34 is formed to be smaller than the inner diameter of the cylinder 2, and accordingly, a clearance with an inner circumferential wall of the cylinder 2 is provided. A circumferential groove 34e (refer to FIG. 2A) is formed over the entire circumference on the outer circumferential surface of the flange portion of the lid 34, and a slide assist ring 2d is disposed in the circumferential groove 34e.

At the center of the lid 34, a communication hole 34d is formed penetrating. In addition, a front end (small-diameter portion) of the second rod 58 passing through the second hydraulic chamber 32 is inserted to the middle of the communication hole 34d.

At two locations on outside of the communication hole 34d of the lid 34 in the radial direction, communication holes 34b that penetrate through the lid 34 are formed. The communication hole 34b is in communication with the communication hole 39c of the lid 39 by the inside of the collar 28 disposed in the second hydraulic chamber 32.

Further, four through-holes 34f into which the expansion stop bolts 34g are inserted are formed on the outside of the communication hole 34d in the lid 34 in the radial direction (refer to FIG. 2A).

As described above, the expansion stop bolt 34g inserted into the through-hole 34f is fixed to the lid 34 at the head portion thereof, and the screw portion of the front end is screwed into the through-hole 39f of the lid 39 and is biased in the output direction by the locking bolt 39h screwed to the lid 39.

The expansion stop bolt 34g is used to suppress not only the expansion in the radial direction but also the expansion in the axial direction of the thin portion 15 of the second housing 62 by the pressure of the second hydraulic chamber 32 on the inside thereof, but conversely, in order to prevent the thin portion 15 from being contracted in the axial direction by tightening, the spacer 80 is disposed between the protruding portion of the lid 39 and the protruding portion of the lid 34.

In other words, in order to keep the distance constant between the lid 39 and the lid 34 disposed at the both ends of the second housing 62 and having the protruding portion that protrudes inward, the expansion stop bolt 34g and the spacer 80 are used and the locking bolt 3911 is supplementally used. By keeping the distance between the lid 39 and the lid 34 constant, the lid 39 and the lid 34 are fixed and the length of the second housing 62 is kept constant.

Since FIGS. 3A to 3C illustrate the spacer 80, FIG. 3A is a perspective view when viewed from the output side, FIG. 3B is a perspective view when viewed from the input side, and FIG. 3C is an explanatory view illustrating a disposition relationship between the spacer 80 and other components.

As illustrated in FIGS. 3A to 3C, the spacer 80 is formed with a through-hole 80a, an oil passage 80b, a U-shaped groove 80c, and a U-shaped groove 80d. The oil passage 80b, the U-shaped groove 80c, and the U-shaped groove 80d are each formed at a position where interference is avoided.

The through-hole 80a is formed penetrating in the axial direction at the center of the spacer 80. In the through-hole 80a, as illustrated in FIG. 3C, the third intake/exhaust rod 8a having the intake/exhaust path 8b and the small-diameter portion of the second rod 58 penetrate in order from the center, and further on the outside, in the second hydraulic chamber 32 spaced by the stepped portion 58a (second rod 58), the small-diameter projecting portion 39g of the lid 39 is inserted to the middle (the groove bottom surface of the oil passage 80b).

The oil passage 80h is grooves formed at equal intervals in the radial direction on the surface on the output side. In the spacer 80, as illustrated in FIGS. 1A, 1B, and 2A, the small-diameter projecting portion 39g of the lid 39 is inserted into the through-hole 80a to the position (or near position) of the groove bottom surface of the oil passage 80b. Accordingly, in a case where the stepped portion 58a of the second rod 58 moves in the output direction, the oil that exists between the outer circumferential surface of the small-diameter portion of the second rod 58 and the inner circumferential surface of the through-hole of the lid 39 (second hydraulic chamber 32) moves to the outside of the spacer 80 through the oil passage 80b, and the pressure in the second hydraulic chamber 32 increases.

The U-shaped groove 80c and the U-shaped groove 80d are grooves for disposing the collar 28 and the expansion stop bolt 34g, respectively, and are formed over the entire length of the spacer 80. The ti-shaped grooves 80c are formed at two opposing locations and the U-shaped grooves 80d are formed at four locations respectively in accordance with the number of the collars 28 and the number of the expansion stop bolts 34g that are disposed.

The reason why the U-shaped groove 80c and the U-shaped groove 80d are not the through-holes that extend over the entire length of the spacer 80 but the U-shaped grooves in which the outer circumferential surface side is open is as follows. In other words, this is because the second hydraulic chamber 32 is filled with oil after disposing the collar 28 and the expansion stop bolt 34g, but while air remains between the collar 28 and the like and the through-hole in a case where the U-shaped groove is a through-hole, the U-shaped grooves 80c and 80d can eliminate the remaining air from the open outer circumferential surface side.

Returning to FIGS. 1A to 2C, the first housing 61 is disposed on the output side of the second housing 62.

A lid 27 is fixed to an end portion on the input side of the first housing 61 with a plurality of bolts 27e.

The lid 27 is fixed to the lid 34 of the second housing 62 from the inside of the first housing 61 with bolts 27a in a state of being fixed to the first housing 61. Accordingly, the first housing 61 and the second housing 62 are connected to each other.

On the output side of the lid 27, a recessed portion 27g (refer to FIG. 2A) is formed. The recessed portion 27g functions as an end surface of the first pneumatic chamber 21 on the input side.

On the lid 27, a communication hole 27b penetrating the bottom surface of the recessed portion 27g and communicating with the communication hole 34d of the lid 34 is formed, and a communication groove 27d connected to the communication hole 27b is formed in the radial direction on the bottom surface of the recessed portion 27g.

In addition, a groove 27c in the axial direction is formed over the entire length on the outer circumferential surface of the lid 27. In addition, on the lid 27, an L-shaped communication hole 27f having an L-shaped section, extending to the inside in the radial direction from a position connected to the groove 27c and bent from the middle to the input side in the axial direction, is formed. The L-shaped communication hole 27f is connected to the communication hole 34b of the lid 34 by penetrating to the end surface of the lid 27 on the input side. Accordingly, the groove 27c formed on the outer circumferential surface of the lid 27 forms an air passage (part of second air passage) from the fifth pneumatic chamber 65 by the L-shaped communication hole 27f, the communication groove 34c of the lid 34, the collar 28, the communication hole 39c and the recessed portion 39d of the lid 39.

Meanwhile, the groove 27c is connected to a communication groove 61e formed on the outer circumference of the first housing 61 (will be described later).

In a state where the lid 27 is fixed to the lid 34 with the bolt 27a, the first piston 11 in which the first rod 50 extends at the center is disposed in the first housing 61.

By disposing the first piston 11, the first housing 61 is divided by the first piston 11, whereby the first pneumatic chamber 21 is formed on the input side, and the fourth pneumatic chamber 64 is formed on the output side.

As illustrated in FIG. 2B, circumferential grooves 61a and 61b are formed over the entire circumference on both end sides of the first housing 61. As described above, the slide assist rings 2b and 2c are fitted into the circumferential groove 61a, and the sliding with the cylinder 2 is made smooth.

In addition, in the first housing 61, a communication groove 61e is formed in the axial direction (longitudinal direction) over the entire length. The end portion on the input side of the communication groove 61e is connected to the communication groove 27c of the lid 27,

At a location at which the circumferential grooves 61a and 61b and the communication groove 61e intersect with each other, in order not to block the communication groove 61e by the slide assist rings 2b and 2c fitted into the circumferential grooves 61a and 61b, recessed portions 61c and 61d wider and deeper than the slide assist rings 2b and 2c are formed. A passage of air from the fifth pneumatic chamber 65 is a space between the communication groove 61e and the inner circumferential surface of the cylinder 2.

The groove 63c, the communication groove 61e including the recessed portion 61d and the recessed portion 61c, the communication groove 27c, the L-shaped communication hole 27f, the communication hole 34b, the collar 28, the communication hole 39c, and the recessed portion 39d function as the second air passage for supplying the air supplied to the third pneumatic chamber 41 to the fifth pneumatic chamber 65.

Returning to FIGS. 1A and 1B, the third housing 63 is fixed with a plurality of bolts 63e to the end portion of the first housing 61 on the output side in which the first piston 11 is disposed inside.

On the output side of the third housing 63, a recessed portion 63a is formed. A through-hole 63b (refer to FIG. 2A) is formed at the center of the bottom surface of the recessed portion 63a, and the first rod 50 is inserted into the through-hole 63b.

A flange portion is formed in the middle of the third housing 63 in the axial direction, and a groove 63c is formed on the outer circumference of the flange portion.

In addition, on the flange portion of the third housing 63, an L-shaped communication hole 63d having an L-shaped section, extending in the radial direction from a position connected to the groove 63c and bent from the middle in the axial direction, is formed.

The L-shaped communication hole 63d is connected to the fourth pneumatic chamber 64 by penetrating to the end surface of the third housing 63 on the input side.

Meanwhile, in the groove 63c, the input side is connected to the communication groove 61e formed on the outer circumference of the first housing 61, and the output side is connected to the third pneumatic chamber 41. In addition, the third pneumatic chamber 41 and the fourth pneumatic chamber 64 are connected to the fifth pneumatic chamber 65 by the communication groove 61e, the collar 28, and the like.

The groove 63c and the L-shaped communication hole 63d function as the first air passage for supplying the air supplied to the third pneumatic chamber 41 to the fourth pneumatic chamber 64 formed on the output side of the first piston.

The third piston 13 having an output rod 7 formed at the center is disposed in the recessed portion 63a of the third housing 63.

By disposing the third piston 13, the recessed portion 63a of the third housing 63 is divided, and the first hydraulic chamber 31 is formed on the input side.

The third piston 13 is formed with an oil supply hole for filling the first hydraulic chamber 31 with oil, and is sealed by an oil filler plug 38 after the oil is injected.

In addition, at the center of the first hydraulic chamber 31 and the output rod 7, a hollow portion 7a which does not penetrate in the axial direction is formed. The hollow portion 7a also forms the first hydraulic chamber 31, and the inside of the hollow portion 7a is also filled with oil.

The hollow portion 7a is formed such that the inner diameter thereof is larger than the diameter of the first rod 50, and accordingly, the first rod 50 goes in and out.

A retaining ring 37a is fixed to the end portion of the third housing 63 on the output side with a plurality of bolts 37b. Fixing of the retaining ring 37a is performed in a state where the third piston 13 is disposed in the recessed portion 63a, oil is filled, and closed by the oil filler plug 38.

On surfaces opposing each other in the third piston 13 and the retaining ring 37a, the recessed portions 13h and the recessed portions 37c are formed, respectively, and a coil spring 36 for biasing the third piston 13 to the input side is disposed.

The second housing 62 forms an input-side housing together with the lid 39 and the lid 34, and the first housing 61 and the third housing 63 configure an output-side housing together with the lid 27 and the retaining ring 37a.

Further, by fixing the lid 34 and the lid 27 with the bolt 27a, the input-side housing is fixed to the input side(one end side) of the output-side housing.

Next, two types of actuations by the cylinder device I of the first embodiment will be described.

### First Actuation

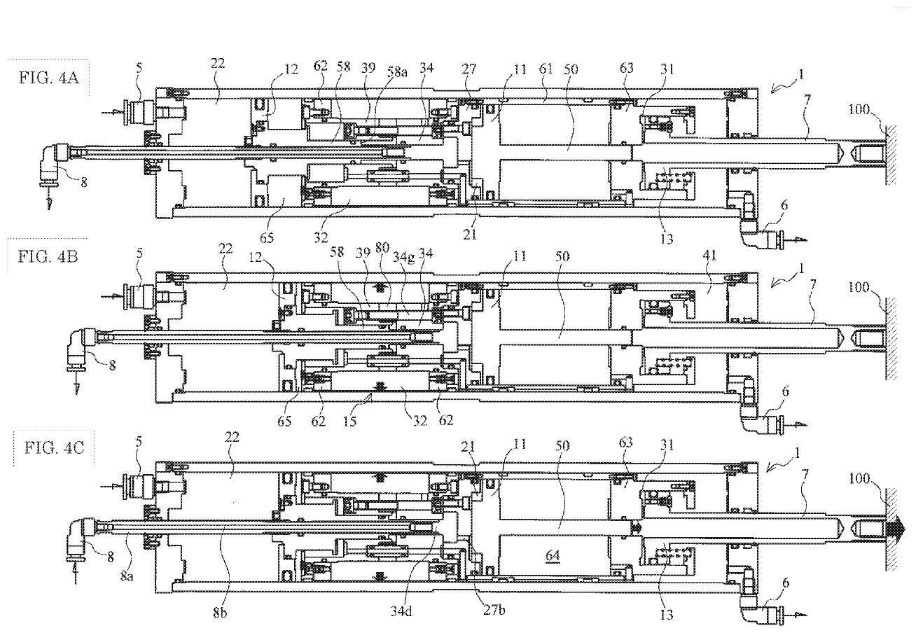

FIGS. 4A to 4C illustrate each state of the first actuation by the cylinder device 1.

In the first actuation, the front end of the output rod 7 abuts on a workpiece 100 to fix the piston housing 60 (61, 62, and 63) to the cylinder 2., and thereafter, the amplified hydraulic pressure is output from the front end of the output rod 7 at any timing.

First, an actuation of setting the cylinder device 1 in the initial state will be described with reference to FIGS. 1 A and 1B.

The initial state of the cylinder device 1 corresponds to the state illustrated in FIGS. 1A and 1B in a state where the piston housing 60 and the second piston 12 in the cylinder 2 are moved to the input side.

In order to set the initial state, in a state where the first inlet/outlet 5 and the third inlet/outlet 8 are open, air is supplied from the second inlet/outlet 6 at a predetermined pressure.

The air supplied to the third pneumatic chamber 41 presses the end surface of the piston housing 60 on the output side that forms the third pneumatic chamber 41, and the entire piston housing 60 starts to move in an input direction.

At this time, the air supplied to the third pneumatic chamber 41 reaches the fifth pneumatic chamber 65 passing through the groove 63c, the communication groove 61e including the recessed portion 61d and the recessed portion 61c, the communication groove 27c, the L-shaped communication hole 27f, the communication hole 34b, the collar 28, the communication hole 39c, and the recessed portion 39d which function as the second air passage. The air supplied to the fifth pneumatic chamber 65 presses the end surface of the second piston 12 on the output side and moves to the input side. At this time, since the first inlet/outlet 5 is open, the second piston 12 and the second rod 58 do not receive the air pressure in an output direction by the second pneumatic chamber 22, and thus can easily move in the input direction.

In addition, the second piston 12 and the second rod 58 move to the input side, and the flange portion 58c is engaged with the retaining ring 29. The piston housing 60 after the flange portion 58c is engaged with the retaining ring 29 is pulled to the input side by the flange portion 58c via the retaining ring 29, and as the end surface on the output side of the piston housing is pressed to the input side by the air of the third pneumatic chamber 41, the piston housing moves until the second piston 12 abuts on the lid 3.

With the movement of the second piston 12 to the input side, the air in the second pneumatic chamber 22 is discharged from the first inlet/outlet 5.

In addition, the air supplied from the second inlet/outlet 6 passes from the third pneumatic chamber 41 to the groove 63c and the L-shaped communication hole 63d, and the pressure in the fourth pneumatic chamber 64 also increases. The pressure from the fourth pneumatic chamber 64 causes the first piston 11 to move to the input side until abutting on the lid 27. At this time, the air that exits in the first pneumatic chamber 21 is pushed by the first piston 11, passes through the communication groove 27d, the communication hole 27b, the communication hole 34d, and the air intake/exhaust path 8b, and is released from the third inlet/outlet 8.

In addition, the output rod 7 and the third piston 13 are biased to the input side by the increase in pressure of the third pneumatic chamber 41 and the coil spring 36 and move to the input side. At the same time, as the first piston 11 moves to the input side, the oil at the recessed portion 63a part on the inside of the first hydraulic chamber 31 flows into the hollow portion 7a of the output rod 7, and accordingly, the space of the first hydraulic chamber 31 in the recessed portion 63a decreases and the third piston 13 moves to the input side. The third piston 13 moves until abutting on the bottom surface of the recessed portion 63a of the third housing 63.

By the above-described movement, the cylinder device 1 is in the initial state illustrated in FIGS. 1A and 1B.

In the initial state, as illustrated in FIG. 4A, the third inlet/outlet 8 and the second inlet/outlet 6 are opened, and the air is supplied from the first inlet/outlet 5.

Then, the pressure of the second pneumatic chamber 22 increases, the second piston 12 is pushed to the output side, and the second piston 12 presses the second hydraulic chamber 32 by the stepped portion 58a of the second rod 58. At this time, since the reaction force of the pressing force to the output side does not act on the entire piston housing 60, the oil in the second hydraulic chamber 32 is not narrowed, and the thin portion 15 is not elastically deformed. Therefore, as the stepped portion 58a of the second rod 58 presses the second hydraulic chamber 32, the entire piston housing 60 moves to the output side.

In addition, since the third inlet/outlet 8 is open, the air pressure of the first pneumatic chamber 21 does not increase, and thus, the first piston 11 and the first rod 50 do not move in the output direction with reference to the piston housing 60, and remains while abutting on the lid 27. Further, since the first rod 50 does not move in the output direction, the hydraulic pressure in the first hydraulic chamber 31 does not increase, either, and the third piston 13 also remains while abutting on the third housing 63.

In addition, as illustrated in FIG. 4A, with the movement of the second piston 12 and the piston housing 60, the output rod 7 also moves in the output direction, and the front end portion of the output rod 7 abuts on the workpiece 100.

When the output rod 7 abuts on the workpiece 100, the movement of the entire piston housing 60 is stopped because the third piston 13 abuts on the third housing 63.

In the state, the air is further supplied from the first inlet/outlet 5 as illustrated in FIG. 4B. Then, since the piston housing 60 stops moving, the pressure in the second pneumatic chamber 22 further increases, and the second piston 12 and the second rod 58 move in the output direction.

In addition, although the volume of the fifth pneumatic chamber 65 is reduced by the movement of the second piston 12, the air in the fifth pneumatic chamber 65 moves to the third pneumatic chamber 41 and is discharged from the second inlet outlet 6. As a specific path, as illustrated in FIGS. 1A and 1B, there is a path, for discharging the air from the second inlet/outlet 6, which passes from the fifth pneumatic chamber 65 through the recessed portion 39d, the communication hole 39c, the collar 28, the communication hole 34b, the L-shaped communication hole 27f, the communication groove 27c, the communication groove 61e, the groove 63c, and the third pneumatic chamber 41.

By the movement of the second rod 58, the second hydraulic chamber 32 is pressed by the stepped portion 58a, and the internal pressure increases. By the hydraulic pressure, the thin portion 15 of the second housing 62 is elastically deformed outward and fixed to the cylinder 2 as indicated by an arrow in the radial direction in FIG. 4B. Accordingly, the piston housing 60 is set to be in a state of being fixed to the cylinder 2 in the thin portion 15 from a state where the movement has just stopped.

In addition, since the lid 39 and the lid 34 at both ends of the thin portion 15 are stopped by the expansion stop bolt 34g, the thin portion 15 of the second housing 62 does not extend in the longitudinal direction due to the increase in internal pressure of the second hydraulic chamber 32, and is elastically deformed so as to expand in the radial direction.

In addition, in a state where the second housing 62 is not fixed by the thin portion 15, the piston housing 60 is in a non-fixed state (state of FIG. 4A) where the piston housing 60 cannot move and stops.

In the non-fixed state, when the air supply from the first inlet/outlet 5 is stopped and the air is supplied from the third inlet/outlet 8, the entire piston housing 60 moves in an opposite direction (input direction), In other words, although the pressure of the first pneumatic chamber 21 causes the first piston 11 and the first rod 50 to move and the hydraulic pressure in the first hydraulic chamber 31 increases, the output rod 7 is fixed by the workpiece 100, and thus, the reaction force from the workpiece 100 causes the entire piston housing 60 to move in the opposite direction (input direction).

Here, as to whether the piston housing 60 is fixed by the elastic deformation of the thin portion 15, by disposing a strain gauge (not illustrated) in the outer circumferential portion of the cylinder 2, by detecting deformation strain of the cylinder 2 generated by the pressing force on the cylinder 2 by the thin portion 15, and by detecting a predetermined strain amount, it is determined whether the piston housing 60 is fixed. Otherwise, by disposing a pressure sensor (not illustrated) for detecting the pressure in the second hydraulic chamber 32, whether the piston housing is fixed may be determined based on whether the pressure exceeds a predetermined value (a value at which the thin portion 15 is elastically deformed). In addition, a detection target by the pressure sensor may be the second pneumatic chamber 22. Further, instead of the pressure sensor, by providing a sensor for detecting the movement of the output rod 7 and a sensor for detecting the movement of the intake/exhaust rods 8a, when a predetermined period of time (period of time during which the pressure in the second hydraulic chamber increases and the thin portion 15 is elastically deformed) elapses after the movement is stopped, it may be determined that the piston housing 60 is fixed.

In the state of FIG. 4B where the piston housing 60 is fixed to the cylinder 2 by the elastic deformation of the thin portion 15, the output rod 7 only abuts on the workpiece 100 and the amplified thrust from the front end of the output rod 7 is not output.

Here, as illustrated in FIG. 4C at a desired timing, when the air is supplied from the third inlet/outlet 8, the supplied air passes through the intake/exhaust path 8b, the communication hole 34d, the communication hole 27b, and the pressure in the first pneumatic chamber 21 increases.

Then, the first piston 11 receives the pressure of the first pneumatic chamber 21, and as illustrated by the thick arrow, the front end of the first rod 50 presses the first hydraulic chamber 31, and the third piston 13 receives the amplified hydraulic pressure. The third piston 13 receives the amplified hydraulic pressure to increase the thrust, and a large thrust is output from the output rod 7 to the workpiece 100.

At this time, in a case where the workpiece is deformed or moved by the large thrust of the output rod 7, a stroke due to the hydraulic pressure is generated in the output rod 7 accordingly. In other words, only while the workpiece is being deformed or moved, the output rod 7 is moved in the output direction by the amplified hydraulic pressure, and the movement is stopped while the workpiece is stopped.

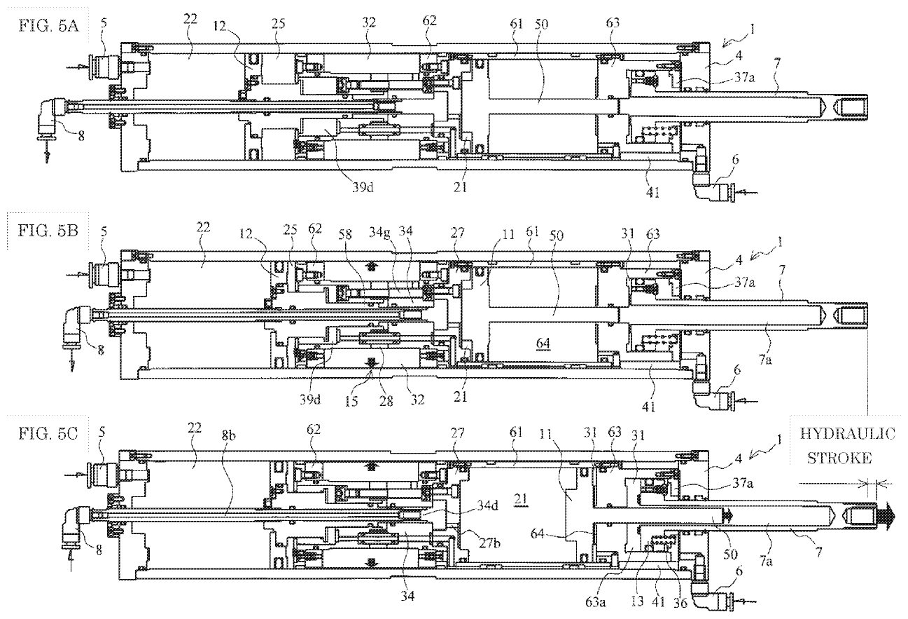

The movement of the output rod 7 is generated as the first piston 11 receives the pressure of the first pneumatic chamber 21 and moves to the output side and the first rod 50 presses the first hydraulic chamber 31, but a specific actuation is the same as the actuation of FIGS. 5B to 5C which will be described later.

### Second Actuation

Next, a second actuation from initial state illustrated in FIGS. 1A and 1B will be described.

FIGS. 5A to 5C illustrate each state of he second actuation by the cylinder device 1.

In the second actuation, before the front end of the output rod 7 abuts on the workpiece 100, the end portion (retaining ring 37a) of the piston housing 60 on the output side abuts on the lid 4, and accordingly, the movement of the piston housing 60 stops, and after this, the amplified hydraulic pressure is output from the front end of the output rod 7 at any timing.

In the initial state, as illustrated in FIG. 5A, the third inlet/outlet 8 and the second inlet/outlet 6 are opened, and the air is supplied from the first inlet/outlet 5.

Similar to the description in FIG. 4A, the supply of the air from the first inlet/outlet 5 causes the second piston 12 and the piston housing 60 (61, 62, and 63) to move in the output direction,

In addition, unlike the first actuation, in the second operation, before the front end of the output rod 7 abuts on the workpiece 100 and the piston housing 60 stops moving, as the retaining ring 37a positioned on the most output side of the piston housing 60 abuts on the lid 4, the movement of the entire piston housing 60 is stopped.

In the state, the air is further supplied from the first inlet/outlet 5 as illustrated in FIG. 5B. Then, similar to the first actuation described with reference to FIG. 4B, the second piston 12 and the second rod 58 move in the output direction due to the increase in pressure in the second pneumatic chamber 22, and the hydraulic pressure in the second hydraulic chamber 32 increases. Accordingly, the thin portion 15 is elastically deformed in the radial direction, and the entire piston housing 60 is fixed to the cylinder 2.

From the state of FIG. 5B where the piston housing 60 is fixed to the cylinder 2 by the elastic deformation of the thin portion 15, as illustrated in FIG. 5C, air is supplied from the third inlet/outlet 8 at a desired timing. Then, the supplied air increases the pressure of the first pneumatic chamber 21 through the intake/exhaust path 8b, the communication hole 34d, and the communication hole 27b. As the first piston 11 receives the increased pressure, the front end of the first rod 50 presses the first hydraulic chamber 31.

The actuation up to this step by the air supply the third inlet/outlet 8 is the same as the first actuation.

However, in the second actuation, as illustrated in FIG. 5B, since no member abuts on the front end of the output rod 7, the third piston 13 and the output rod 7 are movable in the output direction.

Therefore, the front end of the first rod 50 moves in the output direction while pressing the first hydraulic chamber 31, and the first piston 11 and the first rod 50 enter the hollow portion 7a of the output rod 7.

Accordingly, the oil in the hollow portion 7a moves between the outer circumferential surface of the first rod 50 and the inner circumferential surface of the output rod 7 to move to the recessed portion 63a side of the first hydraulic chamber 31. The movement of the oil in the first hydraulic chamber 31 causes the third piston 13 to move in the output direction by a distance (hydraulic stroke) that corresponds to an insertion stroke amount of the first rod 50 into the first hydraulic chamber 31.

In the state, as the front end of the first rod 50 presses the first hydraulic chamber 31, the hydraulic pressure increases, and as the third piston 13 receives the increased hydraulic pressure, a large thrust is output from the front end of the output rod 7.

Although FIG. 5B illustrates a state where the front end of the output rod 7 does not abut on the workpiece, even in a case where the output rod 7 abuts on the work as illustrated in FIGS. 4A to 4C, in a case where the workpiece is deformed or moved by the amplified thrust of the output rod 7, the first rod 50 actuates as illustrated in FIG. 5C, and thus, the hydraulic stroke is generated in the output rod 7.

In addition, when the movement distance (hydraulic stroke) of the output rod 7 until the first rod 50 moves in the hollow portion 7a and the thrust is output from the output rod 7 is set to Lh, and when the insertion stroke amount the movement distance of the first piston 11) to the inside of the first hydraulic chamber 31 of the first rod 50 is set to La, the sectional area of the first rod 50 on the output side in the first hydraulic chamber 31 is set to Sa, and the sectional area of the third piston 13 and the output rod 7 on the input side in the first hydraulic chamber 31 is set to Sh, the following relationship is established.

Lh=La×(Sa/Sh)

As described above, according to the first embodiment, separately from the first inlet/outlet 5 for fixing the piston housing 60 to the cylinder 2 by raising the hydraulic pressure of the second hydraulic chamber 32, the third inlet/outlet 8 is provided to generate a thrust from the front end of the output rod 7.

Accordingly, the fixing actuation of the piston housing 60 and the thrust generation actuation from the output rod 7 can be performed independently.

Further, according to the first embodiment, even in a state where the output rod 7 abuts on the workpiece 100 or in a non-contact state (a state where the retaining ring 37a abuts on the lid 4), it is possible to output the amplified thrust by the hydraulic pressure of the first hydraulic chamber 31 from the front end of the output rod 7.

### Second Embodiment

Next, a cylinder device 1b according to a second embodiment will be described.

In the first embodiment, two switching valves including the switching valve for the first inlet/outlet 5 and the switching valve for the third inlet/outlet 8 are required on the outside of the cylinder 2, but according to the second embodiment, by disposing a check valve 54 that functions as the switching valve on the inside of the cylinder 2, the third inlet/outlet 8 becomes unnecessary. In other words, the external switching valve may be one for the first inlet/outlet 5.

Accordingly, in the second embodiment, the fixing actuation (clamping actuation) for fixing the piston housing 60 to the cylinder 2 with the amplified hydraulic pressure and the hydraulic pressure output actuation of generating the amplified hydraulic pressure at the front end of the output rod 7 by the air hydraulic mechanism can be performed automatically and continuously using the check valve (sphere check valve) 54.

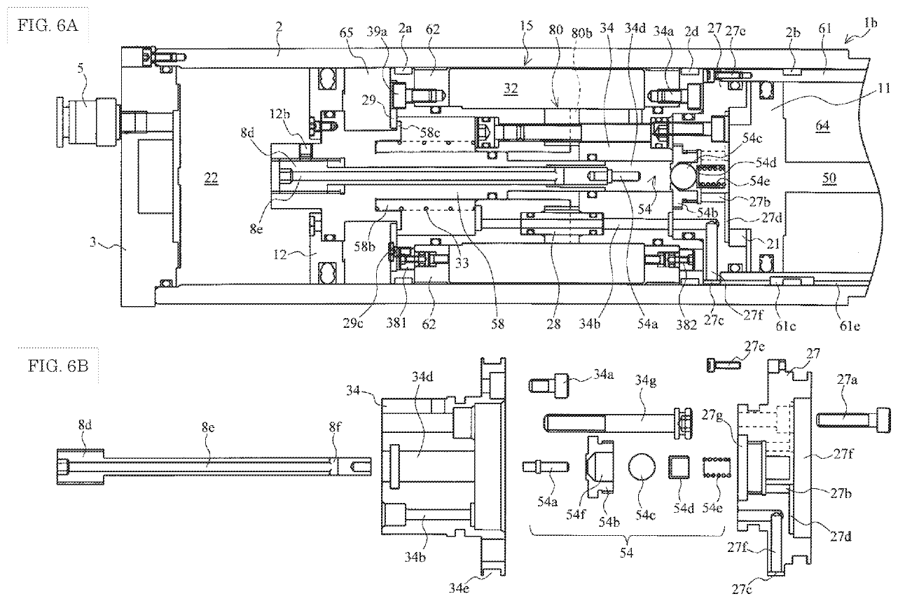

FIG. 6A is a sectional view illustrating a part of the cylinder device 1b in the second embodiment, and FIG. 6B is a sectional view illustrating the components thereof.

In FIGS. 6A and 6B, the periphery of the characteristic check valve 54 of the second embodiment is illustrated, and the other parts include the expansion stop bolt 34g, the locking bolt 39h, and the spacer 80, and are the same as those of the cylinder device 1 of the first embodiment illustrated in FIGS. 1A to 2C.

As illustrated in FIGS. 6A and 6B, in the cylinder device 1b, the check valve 54 is disposed between the lid 27 fixed to the end portion of the first housing 61 on the input side and the lid 34 fixed to the end portion of the second housing 62 on the output side.

The check valve 54 includes an open/close rod 54a attached to the front end of the communication rod 8d, a stop ring 54b, a sphere 54c, a circular cylindrical member 54d, and a coil spring 54e.

The lid 27 is formed with the recessed portion 27g in which the check valve 54 is accommodated. The stop ring 54h is screwed to the lid 27 in a state where the sphere 54c, the circular cylindrical member 54d, and the coil spring 54e are accommodated in the recessed portion 27g.

The coil spring 54e is disposed between the bottom portion of the recessed portion 27g and the bottom portion of the circular cylindrical member 54d, and by biasing the sphere 54c in the input direction via the check valve 54, a vent hole 54f formed in the stop ring 54b is closed by the sphere 54c.

In the intake/exhaust rod 8a in the first embodiment, the input side penetrates the lid 3, the end portion is connected to the third inlet/outlet 8, and a communication path 8e penetrates in the axial direction (refer to FIGS. 1A and 1B).

On the other hand, in the communication rod 8d of the embodiment that corresponds to the intake/exhaust rod 8a, as illustrated in FIGS. 6A and 6B, the end portion on the input side is formed to the end surface of the second rod 58 on the input side, and the communication path 8e is in communication with the second pneumatic chamber 22.

Meanwhile, the end portion of the communication rod 8d on the output side does not penetrate in the axial direction, and is connected to the communication path 8f that is deformed penetrating in the radial direction slightly ahead of the front end surface.

Similar to the first embodiment, the communication rod 8d is inserted into the through-hole formed in the second rod 58, screwed at the end portion on the input side, and fixed in the radial direction with the fixing screw 12b.

Unlike the first embodiment, in the through-hole formed in the second rod 58, the inner diameter on the front end side (mall-diameter portion on the output side) is formed larger than the outer diameter on the output side of the communication rod 8d.

Accordingly, the air in the second pneumatic chamber 22 passes through the communication path 8f from the communication path 8e, and further passes between the outer circumference of the communication rod 8d and the through-hole of the second rod 58, and is supplied to the communication hole 34d.

A recessed portion is formed along the center axis at the front end of the communication rod 8d, and an open/close rod 54a of the check valve 54 is press-fitted therein.

The communication rod 8d functions as communication means for communicating the second pneumatic chamber 22 and the first pneumatic chamber 21 together with the check valve 54, the communication hole 27b, and the communication groove 27d.

In the large-diameter portion of the second rod 58, a recessed portion 58h is formed along the outer circumference of the medium-diameter portion. The medium-diameter portion of the second rod 58 is inserted into the coil spring 33, one end side of the coil spring 33 is disposed in the recessed portion 58b, and the other end side abuts on the bottom surface of the recessed portion 39d formed on the lid 39.

The flange portion 58c that protrudes in the radial direction is formed on the end surface on the output side of the large-diameter portion of the second rod 58.

In the second rod 58, in a state where the small-diameter portion and the medium-diameter portion of the second rod 58 inserted into the coil spring 33 have passed through the lid 39, the retaining ring 29 is fixed to the lid 39 with a bolt 29c from the input side.

The coil spring 33 biases the second rod 58 and the entire piston housing 60 (61, 62, and 63) in a direction of being separated from each other. In other words, the coil spring 33 biases the second rod 58 to the input side with respect to the piston housing 60, and biases the piston housing 60 to the output side with respect to the second rod 58.

Therefore, in a case of placing the cylinder device 1b in the initial state, in addition to the air of the predetermined pressure supplied from the second inlet/outlet 6, it is easy to retain and return the flange portion 58c until abutting on the retaining ring 29 by the biasing force of the coil spring 33. Meanwhile, in the actuation which will be described later, the coil spring 33 assists in pushing the entire piston housing 60 in the output direction.

In addition, the recessed portion 58b and the coil spring 33 provided in the large-diameter portion of the second rod 58 can also be provided in the first embodiment.

Next, the first actuation and the second actuation by the cylinder device 1b of the second embodiment will be described.

### First Actuation

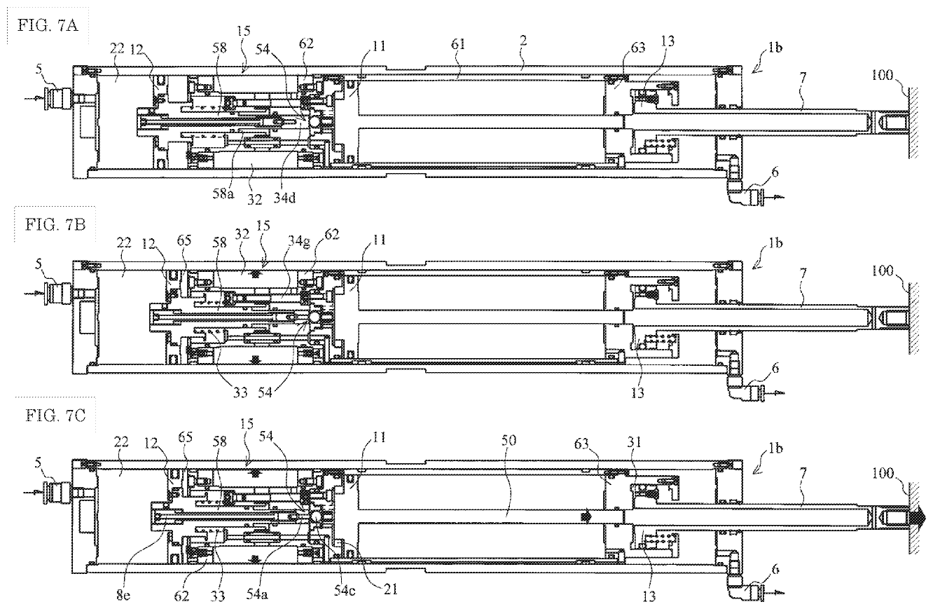

FIGS. 7A to 7C illustrate each state of he first actuation by the cylinder device 1b.

In the first actuation, continuously to the actuation of fixing the piston housing 60 as the front end of the output rod 7 abuts on the workpiece 100, the check valve (ball check valve) 54 automatically actuates, and the amplified hydraulic pressure is output from the front end of the output rod 7.

In a case where the cylinder device 1b is placed in the initial state, in a state where the first inlet/outlet 5 is open, the air is supplied from the second inlet/outlet 6 at a predetermined pressure. Accordingly, each part in the cylinder 2 moves to the input side, but the movement is the same as that of the first embodiment except that it is easy to return the second rod 58 by the biasing force of the coil spring 33.

In addition, FIGS. 6A and 6B illustrate states of not being in the initial state but being moved to the output side.

In the initial state, as illustrated in FIG. 7A, the second inlet/outlet 6 is opened, and the air is supplied from the first inlet/outlet 5.

Then, the pressure of the second pneumatic chamber 22 increases, the second piston 12 is pushed to the output side, and the second piston 12 presses the second hydraulic chamber 32 by the stepped portion 58a of the second rod 58. Here, since the reaction force of the pressing force of the movement on the output side does not act on the entire piston housing 60, the oil in the second hydraulic chamber 32 is not narrowed, and the thin portion 15 is not elastically deformed. Therefore, as the second rod 58 presses the second hydraulic chamber 32, the entire piston housing 60 moves to the output side. The coil spring 33 assists in pushing the entire piston housing 60 in the output direction. The actuations are the same as that described with reference to FIG. 4A, in which the output rod 7 moves in the output direction and the front end portion abuts on the workpiece 100.

In addition, although the pressure in the communication hole 34d also increases passing through the communication paths 8e and 8f due to the pressure increased in the second pneumatic chamber 22, the biasing force of the coil spring 54e (refer to FIGS. 6A and 6B) becomes larger than the movement force to the input side generated in the sphere 54c due to the air pressure, and thus, the check valve 54 remains while being in a sealed state.

When the output rod 7 abuts on the workpiece 100, the movement of the entire piston housing 60 is stopped because the third piston 13 abuts on the third housing 63.

In this state, as illustrated in FIG. 7B, when the air is further supplied from the first inlet/outlet 5, the pressure in the second pneumatic chamber 22 exceeds the biasing force of the coil spring 33, and the second piston 12 and the second rod 58 move in the output direction.

Accordingly, the second hydraulic chamber 32 is pressed by the stepped portion 58a and the internal pressure increases, and the thin portion 15 is elastically deformed outward and the entire piston housing 60 is set to be in a state of being fixed to the cylinder 2 from the state where the movement is stopped.

In FIG. 7C, in a state where the piston housing 60 is fixed to the cylinder 2 by the elastic deformation of the thin portion 15, simultaneously, the open/close rod 54a fixed to the front end of the second rod 58 pushes the sphere 54c and is in a state where the check valve 54 is open,

In this state, the air supplied from the first inlet/outlet 5 flows from the second pneumatic chamber 22 through the communication path 8e, the communication hole 34d, the vent hole 54f, the recessed portion 27g, the communication hole 27b, and the communication groove 27d (refer to FIGS. 6A and 6B), and the pressure in the first pneumatic chamber 21 is increased.

Then, the first piston 11 receives the pressure of the first pneumatic chamber 21, and the front end of the first rod 50 presses the first hydraulic chamber 31, and the third piston 13 receives the amplified hydraulic pressure. The third piston 13 receives the amplified hydraulic pressure, and a large thrust is output from the output rod 7 to the workpiece 100.

At this time, when the second housing 62 is fixed (the state of FIG. 7B) and the open/close rod 54a pushes the sphere 54c to open the check valve 54 (the state of FIG. 7C) are performed substantially at the same time, either one of these may be performed earlier. In a case where the second housing 62 is fixed earlier, then the second piston 12 or the second rod 58 is elastically deformed in the assembled seal member due to the pressurization of the second pneumatic chamber 22, and accordingly, the second rods 58 further move to the output side to open the check valve 54.

In a case where opening the check valve 54 is slightly earlier, air is first supplied to the first pneumatic chamber 21 for a short period of time, the first hydraulic chamber 31 is pressurized and hydraulic pressure is generated, and the output rod 7 does not move because the output rod 7 abuts on the workpiece 100, but the third housing 63 slightly moves to the input side as a reaction force. However, the movement distance of the first piston 11 is slight, and as described above, the movement distance Lh of the output rod 7 satisfies only Lh=La×(Sa/Sh), and thus, the movement does not greatly affect the entire stroke. However, while the second hydraulic chamber 32 is not fixed, a high hydraulic pressure cannot be generated in the output rod 7.

In addition, in a case where the workpiece is deformed or moved after a large thrust is generated in the output rod 7 accordingly, a stroke due to the hydraulic pressure is generated in the output rod 7 accordingly. In other words, only while the workpiece is being deformed or moved, the output rod 7 is moved in the output direction by the amplified hydraulic pressure, and the movement is stopped while the workpiece is stopped. The actuation of the output rod 7 in this case is the same as that of the first embodiment.

Even in the cylinder device 1b of the second embodiment, in a state of not being fixed by the thin portion 15 (the state of FIG. 7A), the piston housing 60 is in a stop state of not being movable.

Here, similar to the first embodiment, as to whether the piston housing 60 is fixed by the elastic deformation of the thin portion 15, by disposing a strain gauge (not illustrated) in the outer circumferential portion of the cylinder 2, by detecting deformation strain of the cylinder 2 generated by the pressing force on the cylinder 2 by the thin portion 15, and by detecting a predetermined strain amount, it is determined whether the piston housing 60 is fixed. Otherwise, by disposing a pressure sensor (not illustrated) for detecting the pressure in the second hydraulic chamber 32, whether the piston housing is fixed may be determined based on whether the pressure exceeds a predetermined value (a value at which the thin portion 15 is elastically deformed). In addition, a detection target by the pressure sensor may be the second pneumatic chamber 22. Further, instead of the pressure sensor, by providing a sensor for detecting the movement of the output rod 7, when a predetermined period of time (period of time during which the pressure in the second hydraulic chamber increases and the thin portion 15 is elastically deformed) elapses after the movement is stopped, it may be determined that the piston housing 60 is fixed.

### Second Actuation

Next, the second actuation from the initial state will be described.

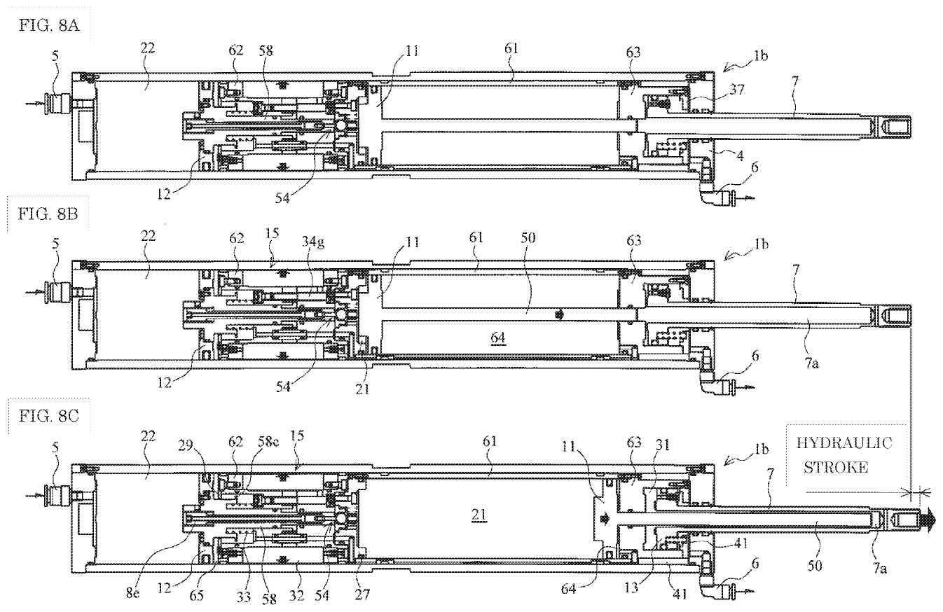

FIGS. 8A to 8C illustrate each state of the second actuation by the cylinder device 1b.

In the second actuation, before the front end of the output rod 7 abuts on the workpiece 100, the end portion (retaining ring 37a) of the piston housing 60 on the output side abuts on the lid 4, and accordingly, the piston housing 60 is fixed. Continuously to the fixing actuation, the check valve 54 is automatically operated to output the amplified hydraulic pressure from the front end of the output rod 7.

In the second actuation in the second embodiment, each part in the cylinder 2 actuates from the initial state to the states illustrated in FIGS. 8A, 8B, and 8C in order.

Then, in each state of FIGS. 8A to 8C, except the check valve 54, the actuations of the second piston 12 and the second rod 58, the piston housing 60 (61, 62, and 63), the first piston 11 and the first rod 50, and the third piston 13 and the output rod 7 are the same as the second actuation described with reference to FIGS. 5A to 5C in the first embodiment.

Meanwhile, the actuation of the check valve 54, the timing at which the check valve 54 opens, or the actuation of the air in the first pneumatic chamber 21 pressurizing the first pneumatic chamber 21 are the same as the actuations of the check valve 54 described in FIGS. 7A to 7C.

However, regarding the timing for fixing the second housing 62 and opening the check valve 54, the communication rod 8d is adjusted and the position of the open/close rod 54a is optimally set such that the timing for opening the check valve 54 is slightly earlier.

Further, the actuation in which the first piston 11 and the first rod 50 move in an advancing direction in the hollow portion 7a in a state where the first pneumatic chamber 21 is pressurized and the thrust is output from the front end of the output rod 7 is the same as the actuation described in FIG. 5C.

In addition, in the second actuation, as illustrated in FIG. 8C, since the first piston 11 largely moves in the first housing 61 in the output direction, the actuation of returning to the initial state is different from the first actuation and as follows.

In a case of returning to the initial state from the state of FIG. 8C, after the first inlet/outlet 5 is opened, the air is supplied from the second inlet/outlet 6 at a predetermined pressure. The air supplied from the second inlet/outlet 6 is supplied to the third pneumatic chamber 41, the fourth pneumatic chamber 64, and the fifth pneumatic chamber 65.

When the air is supplied to the fourth pneumatic chamber 64, the first piston 11 moves until abutting on the lid 27. At this time, the air in the first pneumatic chamber 21 passes through the check valve 54 and is discharged from the first inlet/outlet 5 through the communication path 8e.

At the same time, the second piston 12 and the second rod 58 also start moving in the input direction because air is also supplied to the fifth pneumatic chamber 65, but the first piston 11 is set to have sliding friction smaller than that of the second piston 12 in advance, and the actuation of the first piston 11 is completed before the second piston 12 moves and the check valve 54 is closed.

A difference in sliding friction is made by adjusting the presence or absence of lubricating oil, a difference in the material of the lubricating oil, a difference in material of the packing to be used or the interference.

Meanwhile, due to the opening of the first inlet/outlet 5, the second piston 12 and the second rod 58 do not receive air pressure in the output direction even when the air flows into the second pneumatic chamber 22 through the check valve 54. Therefore, the second piston 12 and the second rod 58 start moving in the input direction by the pressurization by the air supplied to the fifth pneumatic chamber 65 and the biasing force of the coil spring 33. Accordingly, the fixed state of the second housing 62 by the thin portion 15 is released.

Since the third pneumatic chamber 41 and the fourth pneumatic chamber 64 are pressurized by the air supply from the second inlet/outlet 6 and the force acts to move the first housing 61 to the input side, the fixed state of the second housing 62 is released, and at the same time, the entire piston housing 60 (61 to 63) moves to the input side.

The movement of the entire piston housing 60 to the input side may release the fixed state of the second housing 62, and thus, the movement starts before the flange portion 58c abuts on the retaining ring 29.

At this time, in the check valve 54, the open/close rod 54a is set such that the first piston 11 is closed after the actuation is completed, and may be closed before or after the fixed state of the second housing 62 is released.

The second piston 12 moves to the output side until the flange portion 58c abuts on the retaining ring 29 by supplying the air to the fifth pneumatic chamber 65, and further, the second piston 12 abuts on the lid 3, and the entire piston housing 60 stops.

When the first piston 11 abuts on the lid 27, the movement to the input side is completed, and the entire piston housing 60 is in a stop state, the second inlet/outlet 6 is opened. Accordingly, the initial state is achieved.

The completion of the movement of the first piston can be grasped by the intake/exhaust amount of the air from the third inlet/outlet 8 or by the position of the output rod 7.

In addition, in the first actuation described in FIGS. 7A to 7C, the movement of the first piston 11 in the first housing 61 is slight, and thus, the first piston 11 easily completes the movement to the input side before the check valve 54 is closed. Therefore, even when the sliding friction of the first piston 11 and the second piston 12 is not adjusted in advance, the first inlet/outlet 5 is opened, and the air is supplied from the second inlet/outlet 6 to return to the initial state.

As described above, according to the second embodiment, the first inlet/outlet 5 for fixing the piston housing 60 to the cylinder 2 by raising the hydraulic pressure of the second hydraulic chamber 32 is provided, and the check valve 54 is open continuously to the fixing actuation.

The amplified thrust can be output from the front end of the output rod 7 continuously to the fixing of the piston housing 60 to the cylinder 2 only by the air supply from the first inlet/outlet 5.

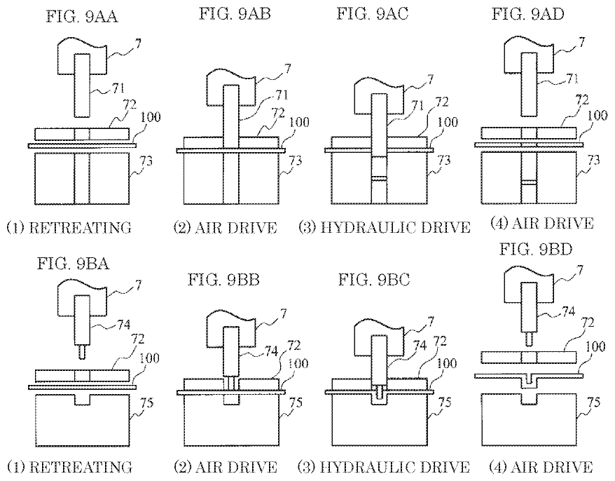

Next, press working using the cylinder device 1 will be described with reference to FIGS. 9AA to 9AD and 9BA to 9BD.

FIGS. 9AA to 9AD are views for describing an example in which the press working (punching) is performed by using the cylinder device 1.

In addition, since the cylinder device 1b is also the same, the cylinder device 1 will be described as an example.

The pressmachine not illustrated fixes the cylinder device 1 with the output direction as a downward direction.

A punch 71 that is a tool for a punching die is fixed at the front end of the output rod 7 so as to be coaxial to the output rod 7, and a mounting stand 73, the workpiece 100, and a jig 72 are mounted from below in order on the lower side thereof. The stand, the workpiece, and the tool function as workpiece mounting means.

The punch 71 has a circular column shape and is a die that drills a circular hole in the workpiece 100 formed of a metal sheet.

During the punching, the jig 72 is a member that presses the workpiece 100 to the mounting stand 73 and fixes the workpiece 100 and is provided a through-hole through which the punch 71 passes.

The mounting stand 73 is also provided with a through-hole to which the punch 71 escapes during the punching.

In the configuration described above, the cylinder device 1 performs the press working in the following order.

(1) First, the first inlet/outlet and the third inlet/outlet 8 are opened and the air is supplied to the second inlet/outlet 6, and thereby the cylinder device 1 is in the initial state. In this manner, the punch 71 retreats, and the workpiece 100 and the jig 72 are mounted at predetermined positions on the mounting stand 73.

(2) Next, the workpiece 100 is pressed and fixed to the mounting stand 73 by the jig 72. In addition, the second inlet/outlet 6 and the third inlet/outlet 8 are opened and the air is supplied from the first inlet/outlet 5.

Then, by air drive, due to the first actuation described in FIG. 4A, the output rod 7 moves forward in the output direction, and the front end of the punch 71 abuts on the workpiece 100.

(3) When the front end of the punch 71 abuts, due to the air supply from the first inlet/outlet 5, as described in FIG. 4B, the pressure in the second hydraulic chamber 32 increases, and as the thin portion 15 is elastically deformed in the radial direction, the entire piston housing 60 is fixed to the cylinder 2. When the fixed state of the piston housing 60 is detected by a strain gauge or the like, air is supplied from the third inlet/outlet 8 while continuing the opening of the second inlet/outlet 6 and the air supply from the first inlet/outlet 5. Due to the air from the third inlet/outlet 8, as described in FIG. 4C, the first pneumatic chamber 21 is pressurized, and accordingly, the front end of the first rod 50 of the first piston 11 amplifies the hydraulic pressure of the first hydraulic chamber 31, and the output rod 7 is driven by the amplified hydraulic pressure. In this manner, the punch 71 is pressed to the workpiece 100 with a strong force, and the workpiece 100 is punched. As described above, the pressmachine includes press means.

(4) When a hole is formed in the workpiece 100, the first inlet/outlet 5 and the third inlet/outlet 8 are opened and the air is supplied from the second inlet/outlet 6. The punch 71 is pulled up by the air drive, and then the workpiece 100 is detached from a predetermined position. As described above, the pressmachine includes detachment means.

FIGS. 9BA to 9BD are views for describing an example in which a recessed portion is formed in the workpiece 100 by the press working by using the cylinder device 1.

A male die 74 is a male die having a circular column shape, has the front end provided with a protrusion for forming the recessed portion, and is coaxially attached to the output rod 7.

A female die 75 is a female die and has a recessed portion formed to receive the protrusion of the male die 74.

In the configuration described above, the cylinder device 1 performs the press working in the following order.

(1) First, the first inlet/outlet 5 and the third inlet/outlet 8 are opened and the air is supplied to the second inlet/outlet 6, and thereby the cylinder device 1 is in the initial state. In this manner, the male die 74 retreats, and the workpiece 100 and the jig 72 are mounted on the female die 75.

(2) Next, the workpiece 100 is pressed and fixed to the female die 75 by the jig 72. In addition, the second inlet/outlet 6 and the third inlet/outlet 8 are opened and the air is supplied from the first inlet/outlet 5. The output rod 7 moves forward in the output direction by the air drive, and the front end of the male die 74 abuts on the workpiece 100.

(3) When the front end of the male die 74 abuts, due to the air supply from the first inlet/outlet 5, the pressure in the second hydraulic chamber 32 increases, and the entire piston housing 60 is fixed to the cylinder 2 by the elastic deformation of the thin portion 15. When the fixed state of the piston housing 60 is detected by a strain gauge or the like, air is supplied from the third inlet/outlet 8 while maintaining the opening of the second inlet/outlet 6 and the state of the first inlet/outlet 5. Due to the air from the third inlet/outlet 8, the first pneumatic chamber 21 is pressurized, and accordingly, the front end of the first rod 50 of the first piston 11 amplifies the hydraulic pressure of the first hydraulic chamber 31, and the output rod 7 is driven by the amplified hydraulic pressure. In this manner, the front end of the male die 74 is pressed to the workpiece 100 with a strong force, and the recessed portion is formed in the workpiece 100.

(4) When the recessed portion is formed in the workpiece 100, the first inlet/outlet 5 and the third inlet/outlet 8 are opened and the air is supplied from the second inlet/outlet 6. The male die 74 is pulled up by the air drive.

### Third Embodiment

Next, a cylinder device 1c according to a third embodiment will be described.

In the second embodiment, by disposing the check valve 54 that functions as an internal switching valve in the cylinder 2, the fixing actuation of fixing the piston housing 60 to the cylinder 2 with the amplified hydraulic pressure and the hydraulic pressure output actuation of generating the amplified hydraulic pressure at the front end of the output rod 7 by the air hydraulic mechanism can be performed automatically and continuously.

In the second embodiment, as described above, in a case of returning to the initial state after the second actuation, air is supplied from the second inlet/outlet 6 at a predetermined pressure after the first inlet/outlet 5 is opened, and the air supplied to the third pneumatic chamber 41 causes the piston housing 60 to move, the air supplied to the fourth pneumatic chamber 64 causes the first piston 11 to move, and the air supplied to the fifth pneumatic chamber 65 causes the second piston 12 and the second rod 58 to move, to the input side, respectively.

Then, with the movement of the first piston 11 in the input direction, the air in the first pneumatic chamber 21 needs to be discharged from the first inlet/outlet 5 through the check valve 54 and thus, before the second piston 12 moves and the check valve 54 is closed, the actuation of the first piston 11 needs to be completed (abut on the lid 27). Therefore, in the second embodiment, the sliding friction of the first piston 11 is set to be smaller than the second piston 12 due to the difference in material of lubricating oil or packing, and the time after the air is supplied until the actuation is completed is shortened.

On the other hand, in the third embodiment, on the passage where the air from the second inlet/outlet 6 is supplied to the fifth pneumatic chamber 65 (specifically, on the L-shaped communication hole 27f passing through the lid 27), an open/close valve 53 that actuates by the movement of the first piston 11 is provided.

When the open/close valve 53 returns to the initial state after the second actuation, the actuation of the first piston 11 is completed and the first piston 11 is in a closed state until abutting on the lid 27, and thus, there is no case where the second piston 12 moves and the check valve 54 is closed.

After the actuation of the first piston 11 is completed, the first piston 11 abuts on the lid 27, and the open/close valve 53 is opened, the air from the second inlet/outlet 6 is supplied to the fifth pneumatic chamber 65 and the second piston 12 moves in the input direction.

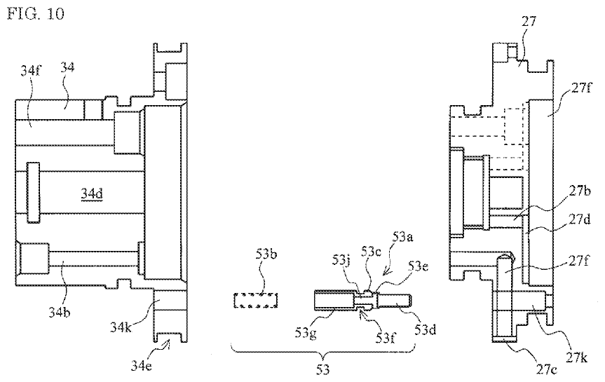

FIG. 10 is a component view of the open/close valve 53 and the periphery thereof in the cylinder device 1c of the third embodiment.

In addition, the cylinder device 1c according to the third embodiment has the same configuration as that of the second embodiment except for the open/close valve 53, the lid 27, and the lid 34 which are illustrated in FIG. 10, and the description thereof will be omitted appropriately.

As illustrated in FIG. 10, the open/close valve 53 is disposed between the lid 34 and the lid 27 so as to move in the input/output direction.

On the lid 27, in the L-shaped communication hole 27f, at the position intersecting with a part that extends in the radial direction, a through-hole 27k for disposing the open/close valve 53 for opening and closing the air passage of the L-shaped communication hole 27f is formed in the axial direction (longitudinal direction). The through-hole 27k is formed with a step by the large-diameter portion on the input side and the small-diameter portion on the output side, and the movement of the open/close rod 53a on the output side is restricted by the step.

The open/close valve 53 includes the open/close rod 53a and a coil spring 53b, and the open/close rod 53a is slidably inserted into the large-diameter portion of the through-hole 27k of the lid 27. The open/close rod 53a slidably penetrates the small-diameter portion of the lid 27 (will be described later) in the axial direction such that the front end thereof comes into contact with and is separated from the first piston 11.

The open/close rod 53a includes a rod portion 53d on the output side, a trunk portion 53c, and a cylinder portion 53g that accommodates one end side (output side) of the coil spring 53b.

In the outer diameter of the trunk portion 53c, the input side has the large-diameter portion formed to have the same diameter as that of the cylinder portion 53g, and the output side has the small-diameter portion formed to have a smaller diameter than that of the cylinder portion 53g. The large-diameter portion of the trunk portion 53c has approximately the same diameter as the inner diameter of the through-hole 27k of the lid 27, and the small-diameter portion formed to be smaller than that of the through-hole 27k.

In the trunk portion 53c, a communication path 53e that penetrates in the radial direction is formed in the small-diameter portion, and an outer circumferential groove 53f is formed on the outer circumferential surface of the large-diameter portion.

In addition, a communication hole 53j that extends in the axial direction at the center of the trunk portion 53c and penetrates from the bottom surface of the circular portion 53g to the communication path 53e, is formed. Accordingly, the through-hole 27k of the lid 27 and a through-hole 34k of the lid 34 communicate with each other via the inside of the cylinder portion 53g, the communication hole 53j, and the communication path 53e, and the air inside the through-hole 27k and the through-hole 34k interlocks with the actuation of the open/close rod 53a and can go back and forth.

The outer circumferential groove 53f is formed at a position connected to the L-shaped communication hole 27f in a state where the open/close valve 53 is open. When the outer circumferential groove 53f and the L-shaped communication hole 27f match each other, air flows in the groove portion of the outer circumferential groove 53f, and the L-shaped communication hole 27f can be communicated.

In the flange portion formed on the output side of the lid 34, the through-hole 34k in the axial direction is formed. In addition, since a bolt 34a for fixing the lid 34 to the second housing 62, a through-hole for passing through the oil filler plug 382, and the like are formed in the flange portion of the lid 34, the through-hole 34k is formed at a position that does not interfere therewith.

The inner diameter of the through-hole 34k has the same diameter as the through-hole 27k of the lid 27, and the coil spring 53b and the cylinder portion 53g of the open/close valve 53 are accommodated so as to slide in the axial direction.

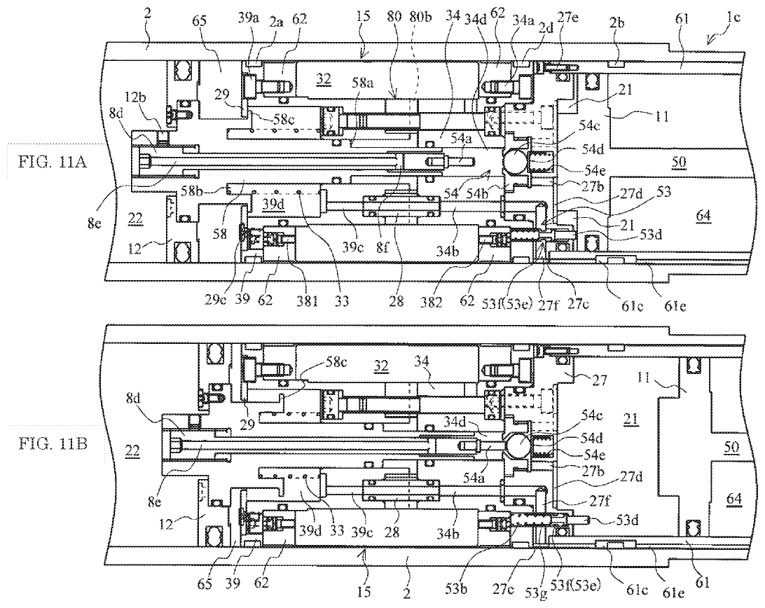

The end portion on the other end side (input side) of the coil spring 53b passes through the through-hole 34k and abuts on the second housing 62 (refer to FIGS. 11A and 11B).

The open/close rod 53a biases the rod portion 53d to the output side by the coil spring 53b.

However, in the initial state of the cylinder device 1 and the like, the open/close valve 53 is opened by pushing the open/close rod 53a to the input side by the first piston 11, and the L-shaped communication hole 27f communicates with the outer circumferential groove 53f.

Then, in the second actuation, as the first piston 11 is separated from the lid 27, the open/close rod 53a is moved to the output side by the biasing force of the coil spring 53b, and in a state where the first piston 11 and the open/close rod 53a are separated, the L-shaped communication hole 27f of the lid 27 is closed by the cylinder portion 53g. In other words, the air flow passage from the second inlte/outlet 6 to the fifth pneumatic chamber 65 is shut off by the open/close valve 53.

Next, the first actuation and the second actuation by the cylinder device 1c of the third embodiment will be described.

FIGS. 11A and 11B are explanatory views illustrating the actuation state of the third embodiment. FIG. 11A illustrates a part of the cylinder device 1c in the initial state, and FIG. 11B illustrates a state in the middle of the second actuation.

### First Actuation

As described above, in the first actuation, as the front end of the output rod 7 abuts on a workpiece 100, the piston housing 60 (61, 62 and 63) is fixed to the cylinder 2, and thereafter, the amplified hydraulic pressure is output from the front end of the output rod 7 at any timing.

At this time, as described above, the check valve 54 is closed until the piston housing 60 (61, 62, and 63) is fixed to the cylinder 2, the air is not supplied to the first pneumatic chamber 21, and thus, the first piston 11 does not actuate. Therefore, the open/close valve 53 is in the open state, and thus, similar to the second embodiment, in accordance with the movement of the second piston 12 in the output direction, the air in the fifth pneumatic chamber 65 is discharged from the second inlet/outlet 6 passing through the second air passage (the recessed portion 39d and the communication hole 39c of the lid 39, the through-hole of the collar 28, the communication hole 34b of the lid 34, the communication groove 27c, the open/close valve 53, the communication groove 61e, the recessed portion 61c, and the third pneumatic chamber 41).

At substantially the same time that the output rod 7 abuts on the workpiece 100 and the piston housing 60 is fixed to the cylinder 2, the check valve 54 is opened, air is supplied to the first pneumatic chamber 21, the front end of the first rod 50 presses the first hydraulic chamber 31, and as a result, the amplified thrust is generated in the output rod 7. At this time, in a case where the abutting workpiece 100 is not deformed or moved by the thrust of the output rod 7, similar to the second embodiment, the first piston 11 remains in a state of abutting on the lid 27 and the open/close valve 53 remains in an open state.

In a case where the workpiece 100 is deformed or moved by the thrust of the output rod 7, the first piston 11 also moves in accordance with the movement distance of the output rod 7. When the first piston 11 moves, the open/close valve 53 is moved in the output direction by the biasing force of the coil spring 53b to be in a closed state, and the communication of the L-shaped communication hole 27f is shut off.

After the first actuation, in a case of returning to the initial state, in a case where the workpiece 100 is not deformed or moved by the thrust of the output rod 7, similar to the second embodiment, the air supplied from the second inlet/outlet 6 passes through the open/close valve 53 and the L-shaped communication hole 27f and is supplied to the fifth pneumatic chamber 65, and causes the second piston 12 and the second rod 58 to move to the input side. In other words, since the first piston 11 is in a state of abutting on the lid 27 and the open/close valve 53 is in the open state, the air supplied from the second inlet/outlet 6 passes through the open/close valve 53 and is supplied to the fifth pneumatic chamber 65, and the second piston 12 and the second rod 58 are immediately moved in the input direction. Accordingly, the fixing of the second housing 62 is released, and the movement of the entire piston housing 60 becomes possible, and at the same time, the movement to the input side is started and the initial state is established.

Since a case where the workpiece 100 is deformed or moved by the thrust of the output rod 7 is the same as a state where the open/close valve 53 is closed, that is, a case where the first piston 11 is moved, the second actuation (will be described later) will be described in detail.

### Second Actuation

Even in the second actuation of the third embodiment, similar to the second embodiment, before the front end of the output rod 7 abuts on the workpiece 100, the retaining ring 37a abuts on the lid 4, and thereafter, the piston housing 60 is fixed to the cylinder 2, and the check valve 54 operates and outputs the amplified hydraulic pressure from the front end of the output rod 7.

In other words, in the initial state illustrated in FIG. 11A, by opening the second inlet/outlet 6 and supplying the air from the first inlet/outlet 5 (not illustrated), the entire second piston housing 60 moves in the output direction, the retaining ring 37a abuts on the lid 4 (not illustrated), and accordingly, the movement of the entire piston housing 60 is stopped.

In this state, when air is further supplied from the first inlet/outlet 5, by the internal pressure of the second hydraulic chamber 32 increased by the movement of the stepped portion 58a of the second rod 58, the thin portion 15 is elastically deformed outward and is fixed to the cylinder 2. At this time, since the lid 39 and the lid 34 at both ends are stopped by the expansion stop bolt 34g, the fact that the thin portion 15 does not extend in the longitudinal direction due to the increase in internal pressure of the second hydraulic chamber 32, and is elastically deformed so as to expand in the radial direction, is the same as those of the first and second embodiments.

As air is further supplied from the first inlet/outlet 5 in a state where the piston housing 60 is fixed, the pressure of the first pneumatic chamber 21 increases and the first piston 11 moves in the output direction, and accordingly the first piston 11 is gradually separated from the lid 27 (refer to FIG. 11B).

In addition, as the first piston 11 moves in the output direction, while maintaining a state where the rod portion 53d abuts on the first piston 11, the cylinder portion 53g and the rod portion 53d move in the output direction by the biasing force of the coil spring 53b, the L-shaped communication hole 27f is closed by the cylinder portion 53g, and the open/close valve 53 is closed.

As air is further supplied to the first pneumatic chamber 21, the first piston 11 is separated from the rod portion 53d and the first rod 50 enters the hollow portion 7a of the output rod 7 (not illustrated).

Accordingly, similar to the first and second embodiments, the front end of the first rod 50 presses the first hydraulic chamber 31, the hydraulic pressure increases, and as the third piston 13 (not illustrated) receives the increased hydraulic pressure, a large thrust is output from the front end of the output rod 7.

Next, an actuation of returning the cylinder device 1c to the initial state after the second actuation will be described.

In a case where the cylinder device 1c returns to the initial state from the state of FIG. 11B, the first inlet/outlet 5 through which the air is supplied is opened, and the air is supplied from the second inlet/outlet 6.

Then, similar to the second embodiment, the air supplied from the second inlet/outlet 6 is supplied to the fourth pneumatic chamber 64 from the third pneumatic chamber 41 (not illustrated, refer to FIGS. 1A and 1B) passing through the groove 63c of the third housing 63 and the L-shaped communication hole 63d, and the pressure in the fourth pneumatic chamber 64 increases and the first piston 11 moves in the input direction.

During this time, the air in the first pneumatic chamber 21 passes through the check valve 54 in the open state, the communication hole 34d, and the communication path 8e, and is output from the first inlet/outlet 5 which is open.

Then, after the first piston 11 moves in the input direction and abuts on the rod portion 53d, until the first piston 11 further moves and abuts on the lid 27, the first piston 11 moves the open/close rod 53a to the input side against the biasing force of the coil spring 53b, and sets the open/close valve 53 in an open state.

When the open/close valve 53 is opened, the air supplied from the second inlet/outlet 6 is supplied from the third pneumatic chamber 41 to the fifth pneumatic chamber 65 passing through the L-shaped communication hole 27f, the recessed portion 39d, and the like.

At this time, since the first inlet/outlet 5 is open, the second piston 12 and the second rod 58 do not receive the air pressure in the output direction by the second pneumatic chamber 22, and thus can easily move in the input direction.

Therefore, air is supplied to the fifth pneumatic chamber 65 by opening the open/close valve 53, and the pressure of the air in the fifth pneumatic chamber 65 and the biasing force of the coil spring 33 cause the second piston 12 and the second rod 58 to move to the input side.

As the second rod 58 moves in the input direction, the pressure in the second hydraulic chamber 32 decreases, the expansion of the thin portion 15 returns to the original state, and the fixed state of the piston housing 60 with respect to the cylinder 2 is released.

In addition, the second piston 12 and the second rod 58 move to the input side, and the flange portion 58c is engaged with the retaining ring 29. The subsequent piston housing 60 is pulled to the input side by the second rod 58 and the second piston 12 via the retaining ring 29, the end surface of the piston housing 60 on the output side is pressed to the input side by the air of the third pneumatic chamber 41, and accordingly, the entire piston housing 60 including the second piston 12 moves to the input side and is set to be in an initial state.

In this manner, by disposing the open/close valve 53 on the passage of the L-shaped communication hole 27f, after the hydraulic pressure is generated from the output rod 7, when returning to the initial state, the first piston 11 has reliably returned (abuts on the lid 27), and after this, it is possible to release the fixing function by the expansion of the thin portion 15.

In addition, in the first and second actuations, in a case where the movement distance of the output rod 7 is small, in accordance with the movement distance, the movement distance of the first piston 11 is small and thus, there is a case where the open/close valve 53 stops together with the first piston 11 at an intermediate position between a fully open state and a fully closed state (half-open state). In a case of returning from such a half-open state to the initial state, the actuation is almost the same as the actuation in the first actuation.

The total movement distance of the open/close valve 53 is originally small, and the movement distance is smaller because of the actuation of returning from the intermediate position. Therefore, the first piston abuts on the lid 27 immediately after the returning actuation starts. Furthermore, as described in the second aspect, since the first piston 11 has less sliding friction and higher moving speed than those of the second piston 12, the first piston 11 reliably abuts on the lid 27 before the check valve 54 is closed.

According to the embodiments described above, it is possible to obtain the following effects.

(1) By internally providing the air hydraulic mechanism in which the air cylinder and the hydraulic cylinder are skillfully combined, the air hydraulic mechanism can be actuated as the air cylinder until abutting on the workpiece 100 and can be actuated as the hydraulic cylinder after abutting on the workpiece 100, and it is possible to realize both of the movement of the long stroke by the air cylinder and the large thrust as the characteristic of the hydraulic cylinder, with only air supply for which there is no need to provide individual ancillary equipment, such as a hydraulic pump, or hydraulic piping or the like requiring labor for construction.

(2) After moving the piston housing 60 as the piston part of the air cylinder by the necessary stroke by air supply, the force in the thrust direction is converted into the force in the radial direction by the elastic deformation of the thin portion 15 in the radial direction, and the piston housing 60 can be fixed into the cylinder 2.

At this time, since the thin portion 15 is restricted from being deformed in the axial direction by the expansion stop bolt 34g and the spacer 80 and elastically deformed only in the radial direction, the piston housing 60 can be reliably fixed.

(3) Since the fixing of the piston housing 60 by elastic deformation in the radial direction can be performed by the hydraulic pressure amplified by the air hydraulic mechanism, the piston housing 60 can be firmly fixed.

(4) A large force can be output to the outside by generating the hydraulic pressure by the air hydraulic mechanism on the inside of the piston housing 60 fixed into the cylinder 2.

(5) Since most of the necessary stroke is covered by the air drive by the air supply and the minimum necessary stroke is obtained by the hydraulic pressure drive by the air supply, the stroke amount of the hydraulic piston may be small, and it is not necessary to provide the hydraulic pressure piping. Therefore, it is possible to minimize the damage caused by oil leakage.

In particular, in a case of a using method in which the output rod 7 abuts on the workpiece 100, and only the hydraulic pressure is applied to the workpiece without movement of the output rod 7 after the abutting, the movement distances of the hydraulic pistons in the hydraulic chambers are all within the range of the elastic deformation of the seal members, and thus it is possible to cause no leakage of oil inside the hydraulic chambers.

(6) In addition, since the check valve 54 is provided in the output air passage, after the clamping actuation is completed by the fixing function, it is always possible to generate a thrust by the hydraulic pressure output function, and it is not necessary to switch the air supply externally, and it is possible to automatically switch without making a mistake in actuation order from the clamping to thrust generation.

(7) Furthermore, since the open/close valve 53 is disposed in the second air passage, there is no need to switch the air supply externally even when returning to the initial state after the thrust generation, and after the first piston 11 returns to the initial state, it is possible to automatically switch without making a mistake in actuation order of releasing the clamp.

What is claimed is:

1. A cylinder device comprising:
a cylinder;
an output-side housing disposed in the cylinder and movable in the cylinder in a thrust direction;
an input-side housing fixed to an input side of the output-side housing and including a second fluid chamber in which a part of an inner surface is formed of a lid on one side and a lid on the other side in the thrust direction, and a fixing mechanism portion of which an outer circumferential surface expands in a radial direction due to an increase in pressure of the second fluid chamber and is fixed to the cylinder;
an air hydraulic mechanism disposed in the output-side housing and outputting a thrust by an amplified fluid pressure in a state of being fixed by the fixing mechanism portion;
a second pneumatic chamber to which air is supplied;
a second piston portion which receives air pressure of the second pneumatic chamber to move the input-side housing and the output-side housing to an output side, and pressurizes and expands the second fluid chamber at a predetermined position; and
distance fixing means for fixing a distance between the lid on the one side and the lid on the other side.

2. The cylinder device according to claim 1,
wherein the air hydraulic mechanism includes:
a first pneumatic chamber to which air is supplied,
a first piston having an air pressure receiving surface that forms one surface of the first pneumatic chamber,
a first rod disposed on the first piston and having a rod end surface smaller in area than the air pressure receiving surface,
a first fluid chamber in which one surface is formed by the end surface of the first rod,
an output piston that forms another one surface of the first fluid chamber and has a fluid pressure receiving surface larger than the end surface of the first rod, and
an output rod disposed on the output piston and outputting a thrust to the outside by a pressure of the first fluid chamber.

3. The cylinder device according to claim 1,
wherein at least one of the first fluid chamber and the second fluid chamber is formed by a hydraulic chamber.

4. The cylinder device according to claim 2,
wherein the distance fixing means penetrates the second fluid chamber, and fixes the lid on the one side and the lid on the other side provided on the output-side housing with a bolt.

5. The cylinder device according to claim 2,
wherein the distance fixing means has a spacer disposed in the second fluid chamber and disposed between the lid on the one side and the lid on the other side while abutting on the lids.

6. The cylinder device according to claim 1,
wherein the second piston portion includes:
a second piston disposed between the input-side housing and the second pneumatic chamber and receiving pressure from the second pneumatic chamber to move to the output side, and
a second rod disposed on the second piston and pressurizing the second fluid chamber by moving to the output side of the second piston.

7. The cylinder device according to claim 6, further comprising:
a third pneumatic chamber provided on the other end side in the cylinder and moving the input-side housing and the output-side housing to the input side.

8. A pressmachine comprising:
the cylinder device according to claim 7;
workpiece mounting means for mounting a workpiece at a predetermined position with respect to the cylinder device;
press means for pressing the mounted workpiece by a tool disposed on the output rod by driving the cylinder device; and
detachment means for detaching the pressed workpiece from the predetermined position.

9. A workpiece clamping apparatus comprising:
the cylinder device according to claim 7;
workpiece mounting means for mounting a workpiece at a predetermined position with respect to the cylinder device;
means for pressing and clamping the mounted workpiece by the output rod by driving the cylinder device; and
means for detaching the fixed workpiece from the predetermined position.

10. A cylinder device actuating method for actuating the cylinder device according to claim 7, the method comprising:
a first step of setting an initial state by moving the input-side housing and the output-side housing to the input side by pressurizing the third pneumatic chamber and depressurizing the first pneumatic chamber and the second pneumatic chamber;
a second step of causing the output rod to abut on a pressing target or causing the output-side housing to abut on an end portion on the output side of the cylinder by moving the input-side housing and the output-side housing to the output side by pressurizing the first pneumatic chamber and depressurizing the third pneumatic chamber;
a third step of fixing the input-side housing and the output-side housing to the cylinder by further pressurizing the second pneumatic chamber to move the second piston and the second rod to the output side and pressurize the second fluid chamber;
a fourth step of pressing the output rod to the target with the amplified fluid pressure of the first fluid chamber by pressurizing the second pneumatic chamber and actuating the air hydraulic mechanism; and
a fifth step of returning to the initial state by moving the input-side housing and the output-side housing to the input side by pressurizing the third pneumatic chamber and depressurizing the first pneumatic chamber and the second pneumatic chamber.

11. A method for pressing a workpiece by actuating the pressmachine according to claim 8, the method comprising:
a first step of setting an initial state by moving the input-side housing and the output-side housing to the input side by pressurizing the third pneumatic chamber and depressurizing the first pneumatic chamber and the second pneumatic chamber;
a second step of mounting the workpiece at a predetermined position;
a third step of moving the input-side housing and the output-side housing to the output side until the output rod abuts on the workpiece and stops by pressurizing the first pneumatic chamber and depressurizing the third pneumatic chamber;
a fourth step of fixing the input-side housing and the output-side housing to the cylinder by further pressurizing the second pneumatic chamber to move the second piston and the second rod to the output side and pressurize the second fluid chamber;
a fifth step of amplifying fluid pressure of the first fluid chamber by pressurizing the second pneumatic chamber and actuating the air hydraulic mechanism;
a sixth step of pressing the workpiece by pressing the workpiece with the fluid pressure amplified in the fifth step by a tool disposed on the output rod;
a seventh step of detaching the output rod and the tool disposed on the output rod from the workpiece by pressurizing the third pneumatic chamber and depressurizing the first pneumatic chamber and the second pneumatic chamber; and
an eighth step of detaching the pressed workpiece from the predetermined position.

12. A method for clamping a workpiece at a predetermined position by actuating the workpiece clamping apparatus according to claim 9, the method comprising:
a first step of setting an initial state by moving the input-side housing and the output-side housing to an input side by pressurizing the third pneumatic chamber and depressurizing the first pneumatic chamber and the second pneumatic chamber;
a second step of mounting the workpiece at a predetermined position;
a third step of moving the input-side housing and the output-side housing to an output side until the output rod abuts on the workpiece and stops by pressurizing the first pneumatic chamber and depressurizing the third pneumatic chamber;
a fourth step of fixing the input-side housing and the output-side housing to the cylinder by further pressurizing the second pneumatic chamber to move the second piston and the second rod to the output side and pressurize the second fluid chamber;
a fifth step of amplifying fluid pressure of the first fluid chamber by pressurizing the second pneumatic chamber and actuating the air hydraulic mechanism; and
a sixth step of pressing the workpiece by the output rod with fluid pressure amplified in the fifth step and clamping the workpiece at the predetermined position.

13. The cylinder device according to claim 2, further comprising:
an output air passage penetrating the second piston portion for supplying air of the second pneumatic chamber to the first pneumatic chamber; and
a check valve disposed on the output air passage, and sets the output air passage in an open state in a state where the fixing mechanism portion fixes the input-side housing to the cylinder.

14. The cylinder device according to claim 13, further comprising:
a third pneumatic chamber formed on the output side of the output-side housing to move the output-side housing to the input side by supply of air;
a first air passage for supplying the air supplied to the third pneumatic chamber to a fourth pneumatic chamber formed on the output side of the first piston;
a second air passage for supplying the air supplied to the third pneumatic chamber to a fifth pneumatic chamber formed on the output side of the second piston; and
an open/close valve disposed on the second air passage and opening and closing the second air passage in accordance with the movement of the first piston,
wherein the open/close valve opens the second air passage after the first piston moves to the input side and discharge of air in the first pneumatic chamber is completed.
